(19) United States
(12) Patent Application Publication
(10) Pub. No.: US 2019/0130423 A1
(43) Pub. Date: May 2, 2019

(54) MANAGEMENT APPARATUS AND MANAGEMENT METHOD

(71) Applicant: HITACHI, LTD., Tokyo (JP)

(72) Inventors: Tohru WATANABE, Tokyo (JP); Masato UTSUMI, Tokyo (JP); Yu IKEMOTO, Tokyo (JP); Yoshihisa OKAMOTO, Tokyo (JP); Ikuo SHIGEMORI, Tokyo (JP); Hiroshi IIMURA, Tokyo (JP); Hiroaki OGAWA, Tokyo (JP)

(73) Assignee: HITACHI, LTD., Tokyo (JP)

(21) Appl. No.: 16/171,578

(22) Filed: Oct. 26, 2018

(30) Foreign Application Priority Data
Oct. 31, 2017 (JP) 2017-210875

(51) Int. Cl. G06Q 30/02; G06Q 10/06

(52) U.S. Cl. CPC G06Q 30/0201; G06Q 10/06375; G06Q 30/0206

(57) ABSTRACT

To solve such a problem, demand categories are prepared. ‘Demand categories’ are units of classification for demand. Where the demand included in the ‘demand categories’ is concerned, any attribute such as the contract type, industry type, demand location, and demand generation period constitute the same demand. For example, a management apparatus comprises a sales income calculation unit which calculates sales income derived from supplying demand by using a time interval-differentiated fee unit price for each demand category and a power usage value, an earnings prediction spread calculation unit which compares earnings for each of a plurality of future volume estimation time series relating to power usage volumes of predetermined periods of the demand categories, and a fee unit price search unit which searches for a fee unit price satisfying a limiting condition based on a comparison result.

### CROSS-REFERENCE TO PRIOR APPLICATION

This application relates to and claims the benefit of priority from Japanese Patent Application number 2017-210875, filed on Oct. 31, 2017 the entire disclosure of which is incorporated herein by reference.

### BACKGROUND

The present invention generally relates to a management technology relating to at least one of energy demand and supply.

Systems which plan for orders placed on a stock exchange to provide supply, relative to the demand that fluctuates on a daily and hourly basis at the supply destination, are known. Trialed systems include the system disclosed in PTL 1 which determines bid volumes and bid prices, tendered to an electric power market, from a power generation plan that is created based on assumed demand data and power source data. Bids which assume prices in the power market uniquely can thus be made.

Systems which perform trading in markets where the regular market conditions change are also known. Trialed systems include the system in PTL 2 which automatically executes orders by dividing a trade quantity into a plurality of slices and associating each of the slices with a time slot of a trading time interval, determines whether a preconfigured change condition of an order schedule is satisfied based on market data in order to flexibly perform automatic adjustment of the order volume according to market trends, and performs a predetermined increase or reduction of a planned execution rate in the order timing when the change condition is satisfied. As a result, trading which satisfies a preconfigured total trading volume can be performed.

[PTL 1] Japanese Laid-Open Patent Application Publication No. 2007-159239

[PTL 2] Japanese Laid-Open Patent Application Publication No. 2008-209987

### SUMMARY

Formulating a plan by taking a holistic approach (for example, overall costs) may be considered. However, it is not necessarily true that a plan that has been formulated by taking a holistic approach is sufficiently desirable. Moreover, problems may also arise concerning other non-planning decisions.

Demand categories have therefore been prepared. Demand categories' are units of classification for demand. Where the demand included in ‘demand categories’ is concerned, any attribute such as the contract type, industry type, demand location, and demand generation period constitute the same demand.

A management apparatus according to a first aspect comprises a sales income calculation unit which calculates sales income derived from supplying demand by using a time interval-differentiated fee unit price for each demand category and a power usage value; an earnings prediction spread calculation unit which compares earnings for each of a plurality of future volume estimation time series relating to power usage volumes of predetermined periods of the demand categories; and a fee unit price search unit which searches for a fee unit price satisfying a limiting condition based on a comparison result.

A management apparatus according to a second aspect comprises a category-differentiated supply cost calculation unit which calculates supply costs differentiated by demand category; a demand category-differentiated earnings calculation unit which calculates earnings which are the difference between supply costs and sales income of a predetermined demand category; and a supply source search unit which searches for a combination of time interval-differentiated supply sources satisfying a limiting condition (for instance, a condition where, even when demand predictions are totally off the mark or contract price predictions are totally off the mark, the start and stoppage plan results are not suspended), based on the earnings.

A management apparatus according to a third aspect, comprising a fee menu value difference estimation unit which estimates a value difference between a payment amount in a fee menu which is a change candidate, pertaining to an electric power fee to be paid by a consumer, and a pre-change fee menu payment amount; a fee menu-differentiated contract proportion estimation unit which estimates a selection proportion (or contract quantity) of each fee menu in a future plan period, based on a fee menu value difference estimation amount; a sales income calculation unit which calculates sales income based on the payment amount; a fee menu-differentiated contract proportion limiting condition input unit which designates an increase/reduction rate of a fee menu-differentiated contract proportion of the demand category; and a fee unit price search unit which determines the fee unit price for which the contract proportion or contract quantity is a predetermined value, based on a designated increase/reduction rate.

A management apparatus according to a fourth aspect comprises a scenario management unit which calculates an earnings prediction spread using a first scenario which is a designated scenario, and an earnings prediction spread using a second scenario which is a scenario in which a demand value of a predetermined demand category or a supply value (supply volume, supply unit price, contract price in electric power market) of a predetermined supply category (the supply category is a classification unit of the supply sources, and supply sources included in the same ‘supply category’ are supply sources for which any of attributes such as the power generation fuel type, capacity, power generation time zone, site location, and the commodity type when performing a wholesale power trading are the same) is added to the demand and supply values of the first scenario, or these demand and supply values are changed; and a demand or supply source additional effect trial calculation unit which compares and displays the earnings prediction spread using the first scenario and the earnings prediction spread using the second scenario.

The present invention contributes toward more desirable planning formulation.

### BRIEF DESCRIPTION OF DRAWINGS

FIG. 1 is a block diagram showing a configuration of functions of an electric power trading planning apparatus according to a first embodiment of the present invention.

FIG. 2 is a diagram showing a hardware configuration according to the first embodiment of the present invention.

FIG. 3 is a sequence diagram according to the first embodiment of the present invention.

FIG. 4 is connective relationship diagram showing the connective relationships between systems according to the first embodiment of the present invention.

FIG. 5 is a flowchart showing processing of the first embodiment of the present invention.

FIG. 6A is a diagram showing an example of a portfolio change according to the first embodiment of the present invention.

FIG. 6B is a diagram showing an example of a portfolio change according to the first embodiment of the present invention.

FIG. 6C is a diagram showing an example of a portfolio change according to the first embodiment of the present invention.

FIG. 7 is a configuration diagram of a data table according to the first embodiment of the present invention.

FIG. 8 is a configuration diagram of a target order transition table according to the first embodiment of the present invention.

FIG. 9 is a configuration diagram of a target order transition table according to the first embodiment of the present invention.

FIG. 10 is a diagram showing a data time interval transition pattern according to the first embodiment of the present invention.

FIG. 11A is a diagram showing a future volume transition candidate pattern according to the first embodiment of the present invention.

FIG. 11B is a diagram showing a future volume estimation amount frequency distribution according to the first embodiment of the present invention.

FIG. 11C is a diagram showing a future volume transition candidate pattern according to the first embodiment of the present invention.

FIG. 11D is a diagram showing a future volume estimation amount frequency distribution according to the first embodiment of the present invention.

FIG. 12 is a diagram showing the relationship between predicted transition measurement values and the result of estimating the predicted transition of the variance value according to the first embodiment of the present invention.

FIG. 13 is a diagram comparing an order system according to the first embodiment of the present invention with a conventional order system.

FIG. 14 is a diagram showing supply results and earnings results of a vendor according to the first embodiment of the present invention.

FIG. 15 is a diagram showing an order transition result according to the first embodiment of the present invention.

FIG. 16 is a block diagram showing a configuration of functions of a trading planning apparatus according to a fifth embodiment of the present invention.

FIG. 17 is a block diagram showing a configuration of functions of a trading planning apparatus according to a sixth embodiment of the present invention.

FIG. 18 is a block diagram showing a configuration of functions of a trading planning apparatus according to a seventh embodiment of the present invention.

FIG. 19 is a block diagram showing a configuration of functions of a trading planning apparatus according to an eighth embodiment of the present invention.

FIG. 20 shows an example of a combination result according to one comparative example according to the sixth embodiment of the present invention.

FIG. 21 is a diagram showing an example of a search result according to the sixth embodiment of the present invention.

FIG. 22 is a diagram showing an example of a screen pertaining to a STEP1 according to the ninth embodiment of the present invention.

FIG. 23 shows an example of a first part of information which is displayed on the screen of FIG. 22.

FIG. 24 shows an example of a second part of information which is displayed on the screen of FIG. 22.

FIG. 25 shows an example of a third part of information which is displayed on the screen of FIG. 22.

FIG. 26 shows an example of a fourth part of information which is displayed on the screen of FIG. 22.

FIG. 27 shows an example of a fifth part of information which is displayed on the screen of FIG. 22.

FIG. 28 shows an example of a sixth part of information which is displayed on the screen of FIG. 22.

FIG. 29 is a diagram showing an example of a screen (execution screen) pertaining to a STEP2 according to the ninth embodiment of the present invention.

FIG. 30 shows an example of a first part of information which is displayed on the screen of FIG. 29.

FIG. 31 shows an example of a second part of information which is displayed on the screen of FIG. 29.

FIG. 32 shows an example of a third part of information which is displayed on the screen of FIG. 29.

FIG. 33 is a diagram showing an example of a screen (save results screen) pertaining to a STEP2 according to the ninth embodiment of the present invention.

FIG. 34 shows an example of a first part of information which is displayed on the screen of FIG. 33.

FIG. 35 shows an example of a second part of information which is displayed on the screen of FIG. 33.

FIG. 36 shows an example of a third part of information which is displayed on the screen of FIG. 33.

FIG. 37 is a diagram showing an example of a screen (execution screen) pertaining to a STEP3 according to the ninth embodiment of the present invention.

FIG. 38 shows an example of a first part of information which is displayed on the screen of FIG. 37.

FIG. 39 shows an example of a second part of information which is displayed on the screen of FIG. 37.

FIG. 40 shows an example of a third part of information which is displayed on the screen of FIG. 37.

FIG. 41 shows an example of a fourth part of information which is displayed on the screen of FIG. 37.

FIG. 42 shows an example of a fifth part of information which is displayed on the screen of FIG. 37.

FIG. 43 is a diagram showing an example of a screen (save results screen) pertaining to a STEP3 according to the ninth embodiment of the present invention.

FIG. 44 shows an example of a first part of information which is displayed on the screen of FIG. 43.

FIG. 45 shows an example of a second part of information which is displayed on the screen of FIG. 43.

FIG. 46 shows an example of a third part of information which is displayed on the screen of FIG. 43.

FIG. 47 is a diagram showing an example of a screen (execution screen) pertaining to a STEP4 according to the ninth embodiment of the present invention.

FIG. 48 shows an example of a first part of information which is displayed on the screen of FIG. 47.

FIG. 49 shows an example of a second part of information which is displayed on the screen of FIG. 47.

FIG. 50 shows an example of a third part of information which is displayed on the screen of FIG. 47.

FIG. 51 shows an example of a fourth part of information which is displayed on the screen of FIG. 47.

FIG. 52 shows an example of a fifth part of information which is displayed on the screen of FIG. 47.

FIG. 53 is a diagram showing an example of a screen (save results screen) pertaining to a STEP4 according to the ninth embodiment of the present invention.

FIG. 54 shows an example of a first part of information which is displayed on the screen of FIG. 53.

FIG. 55 shows an example of a second part of information which is displayed on the screen of FIG. 53.

FIG. 56 shows an example of a third part of information which is displayed on the screen of FIG. 53.

### DESCRIPTION OF EMBODIMENTS

In the ensuing explanation, ‘interface unit’ may refer to one or more interfaces. These one or more interfaces may comprise, of a user interface unit and a communication interface unit, at least the communication interface unit. The user interface unit may be at least one I/O device among one or more I/O devices (for instance, an input device (a keyboard and pointing device, for example) and an output device (a display device, for example)), and a display computer, and may instead or additionally be an interface device for the at least one I/O device. The communication interface unit may be one or more communication interface devices. The one or more communication interface devices may be one or more types of communication interface devices (for instance, one or more NIC (Network Interface Cards)) or may be two or more types of communication interface devices (for instance, an NIC and an HBA (Host Bus Adapter)).

In the ensuing explanation, ‘memory unit’ may refer to one or more memories. At least one memory may be a volatile memory or a nonvolatile memory. The memory unit is mainly used during processing by a processor unit.

In the ensuing explanation, ‘PDEV unit’ may also refer to one or more PDEV. ‘PDEV’ means a physical storage device and is typically a nonvolatile memory device (an auxiliary memory device, for instance), and is an HDD (Hard Disk Drive) or SSD (Solid State Drive), for example. The PDEV unit may be a RAID group. ‘RAID’ is an abbreviation for Redundant Array of Independent (or Inexpensive) Disks.

Furthermore, in the ensuing explanation, ‘storage unit’ includes at least a memory unit among a memory unit and a PDEV unit.

Furthermore, in the ensuing explanation, ‘processor unit’ may refer to one or more processors. At least one processor is typically a microprocessor like a CPU (Central Processing Unit) but may also be another type of processor such as a GPU (Graphics Processing Unit). The one or more processors above may each be a single-core or multi-core processor. A portion of the processors may be a hardware circuit which performs some or all the processing.

Furthermore, in the ensuing explanation, although functions are sometimes explained in the form ‘kkk unit’ (excluding the interface unit, storage unit and processor unit), the functions may also be realized as a result of one or more computer programs being executed by the processor units or may be realized by one or more hardware circuits (for example, an FBGA (Field-Programmable Gate Array) or an ASIC (Application Specific Integrated Circuit)). When the functions are realized as a result of programs being executed by the processor unit, determined processing is performed while suitably using a storage unit and/or an interface unit, and the like, and hence the functions may be implemented by at least a portion of the processor units. Processing which is explained with the function serving as the subject of the sentence may be processing that is performed by a processor unit or a device which comprises a processor unit. A program may be installed from a program source. A program source may be a program distribution computer or a computer-readable recording medium (for example, a non-temporary recording medium). The explanation of each function is an example, and a plurality of functions may be gathered as one function, or one function may be divided into a plurality of functions.

Moreover, although information is explained using expressions such as ‘xxx table’ in the ensuing explanation, the information could also be realized by means of any data structure. In other words, to show the fact that information does not depend on a data structure, ‘xxx table’ can be written as ‘xxx information.’ Moreover, in the ensuring explanation, the configuration of each table is an example, and one table may be divided into two or more tables, or all or a portion of two or more tables could also be one table.

In the ensuing explanation, ‘management apparatus’ may also be configured by one or more computers. More specifically, for example, when a computer comprises a display device and the computer displays information on its own display device, the computer may be a management apparatus. Moreover, for example, when a first computer (a server, for example) transmits display information to a remote second computer (a display computer (a client, for example)) and the display computer displays this information (when the first computer displays information on the second computer), at least the first computer among the first computer and second computer may be the management apparatus. The management apparatus may comprise an interface unit, a storage unit and a processor unit which is connected to the interface unit and storage unit. The action by the computer of the management apparatus to ‘display display information’ could also be an action to display display information on a display device that a computer comprises, or the computer could also transmit display information to the display computer (in the latter case, the display information is displayed by the display computer). Moreover, the functions of the management apparatus may be provided as a result of a computer system which comprises one or more computers (a cloud computing structure, for example) executing one or more computer programs (may be provided as a type of cloud computing service, for example).

A plurality of embodiments is explained in concrete terms hereinbelow with reference to the drawings. In the first to fourth embodiments hereinbelow, for example, a trading planning apparatus is explained as an example of the management apparatus. The management apparatus is explained in the fifth and subsequent embodiments.

### First Embodiment

### [Configuration]

### <<Function Configuration>>

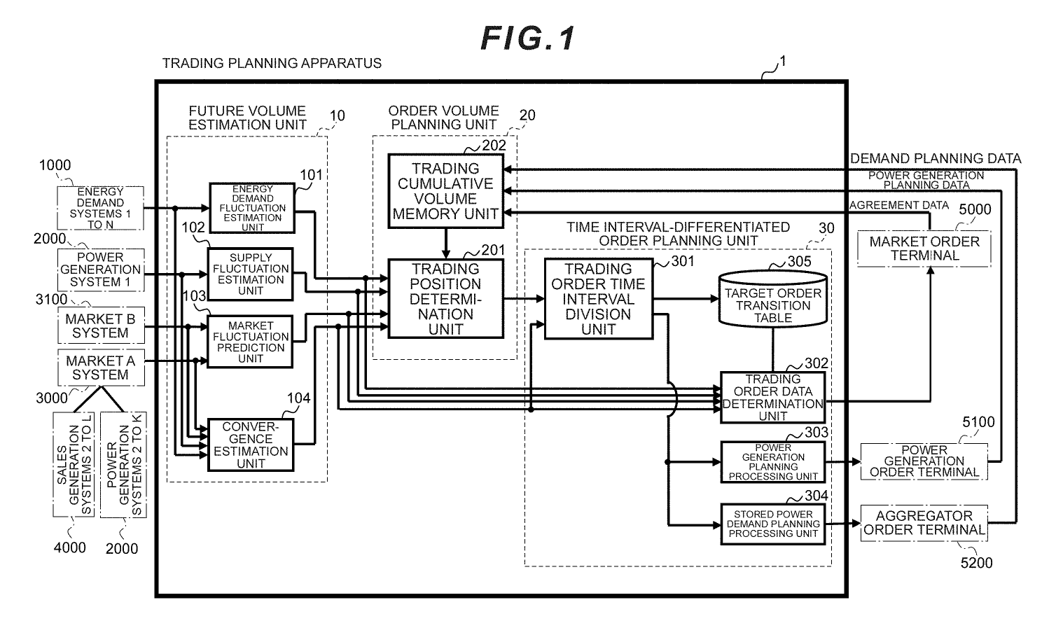

FIG. 1 is a block diagram showing a configuration of functions of an electric power trading planning apparatus according to the first embodiment of the present invention. In FIG. 1, a trading planning apparatus 1 is an apparatus which belongs to a sales business system and which is configured by comprising a future volume estimation unit 10, an order volume planning unit 20, and a time interval-differentiated order planning unit 30. The future volume estimation unit 10 is configured from a demand fluctuation estimation unit 101, a supply fluctuation estimation unit 102, a market fluctuation prediction unit 103, and a convergence estimation unit 104. The order volume planning unit 20 is configured from a trading position determination unit 201 and a trading cumulative volume storage unit 202. The time interval-differentiated order planning unit 30 is configured from a trading order time interval division unit 301, a trading order data determination unit 302, a power generation planning processing unit 303, a stored power demand planning processing unit 304, and a target order transition table 305.

The future volume estimation unit 10 acquires various results data from each of a plurality of demand systems (1 to N) 1000, a power generation business system (1) 2000, a market A system (including sales business systems (2 to L) 4000 and power generation business systems (2 to K) 2000) 3000, and a market B system 3100, estimates future volumes relating to demand and clients in each of the systems, and outputs estimation data to the order volume planning unit 20. In this embodiment in particular, the configuration comprises a convergence estimation unit 104 which estimates an estimation amount (a variance or likelihood value or the like, for example) for data relating to future volume calculation errors which are estimated from result values.

The order volume planning unit 20 is configured from the trading position determination unit 201 which receives future volume estimation data relating to demand and clients from the future volume estimation unit 10, determines trading volumes for a plurality of clients, and outputs the determined content to the time interval-differentiated order planning unit 30; and the trading cumulative volume storage unit 202 which stores the trading cumulative volumes thus far based on contract data from a market order terminal 5000, power generation planning data from a power generation order terminal 5100, and demand planning data from an aggregator order terminal 5200.

The time interval-differentiated order planning unit 30 is configured by comprising the trading order time interval division unit 301 which generates planning period-differentiated data such as trading order volume or available money in a planned trading period which is a segmented period in the elapsed time interval during a trading period when trading is possible, the trading order data determination unit 302 which generates an order telegram for the market and client and the like (a message including the values and quantities of purchase or sales orders), and outputs the generated order telegram (order data) to the market order terminal 5000, the power generation planning processing unit 303 which generates order planning data based on the planning period-differentiated data generated by the trading order time interval division unit 301, and outputs the power generation planning data thus generated to the power generation order terminal 5100, the stored power demand planning processing unit 304 which generates demand planning data based on the planning period-differentiated data generated by the trading order time interval division unit 301 and outputs the demand planning data thus generated to the aggregator order terminal 5200, and the target order transition table 305 which stores the planning period-differentiated data generated by the trading order time interval division unit 301.

### <<Hardware Configuration>>

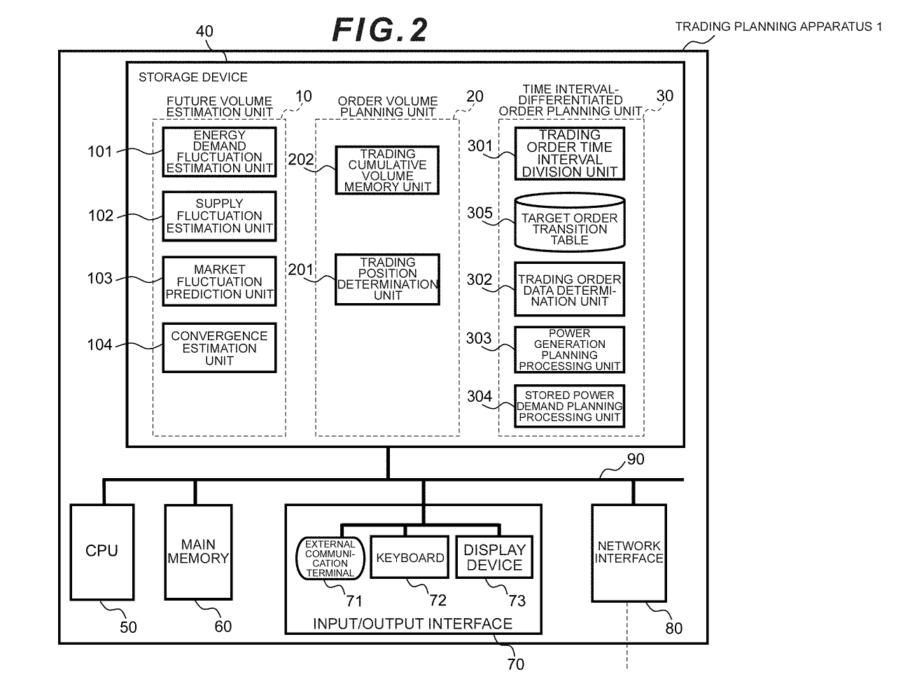

FIG. 2 is a configuration diagram showing the hardware of the trading planning apparatus 1. In FIG. 2, the trading planning apparatus 1 comprises the future volume estimation unit 10, order volume planning unit 20, and a storage device 40 in which programs and data realizing each of the functions of the time interval-differentiated order planning unit 30 are recorded, the CPU 50, a main memory 60, an input/output interface 70 and a network interface 80, each part being connected to a bus 90. The input/output interface 70 is configured comprising an external communication terminal 71, a keyboard 72, and a display device 73. The network interface 80 is connected to order terminals such as external systems (the demand systems 1000 and power generation business system 2000 and the like) and the market order terminal 5000, power generation order terminal 5100, and aggregator order terminal 5200. The input/output interface 70 and network interface 80 are examples of interface units. The storage device 40 is an example of a PDEV unit. The main memory 60 is an example of a memory unit. The CPU 50 is an example of a processor unit.

### <<Trading Processing Sequence Diagram>>

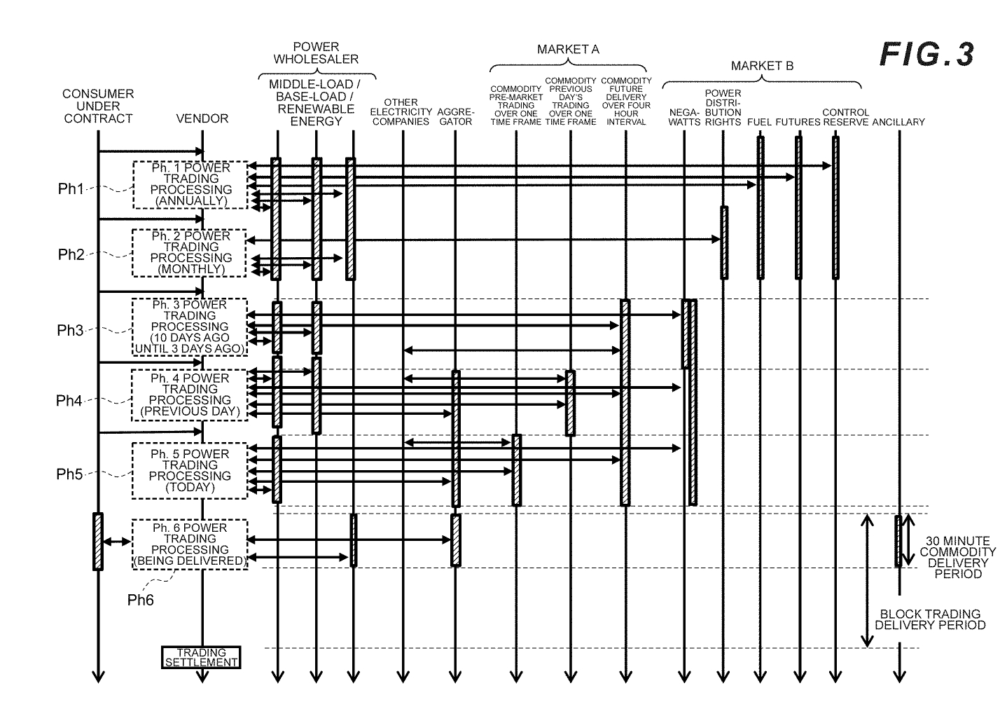

FIG. 3 is a sequence diagram showing power trading processing (phases Ph1 to Ph6), which comprises processing of a trading plan executed by the trading planning apparatus in this embodiment, and processing of other systems which exchange input/output data of the trading processing.

In FIG. 3, the vendor executes phases (power trading processing) Ph1 to Ph6 by using the trading planning apparatus 1. First, the trading planning apparatus 1 executes phase Ph1 which pertains to annual trading based on information relating to fuel, futures, control reserve and power distribution rights in market B (the market B system) and information relating to the middle load, base load and renewable energy of the power wholesaler, and executes phase Ph2 which pertains to monthly trading based on information on power distribution rights in market B and information relating to the middle load, base load and renewable energy of the power wholesaler. Next, the trading planning apparatus 1 executes phase Ph3 which pertains to trading from 10 days ago until 3 days ago based on information relating to negawatts in a market B, information relating to the previous day's commodity trading over one time frame and to 4 hour interval commodity future delivery in a market A, and information relating to the middle load and base load of the power wholesaler, and executes phase Ph4 which pertains to the previous day's trading based on information relating to negawatts in market B, information relating to a previous day's commodity trading over one time frame and 4 hour interval commodity future delivery, in market A, aggregator-related information, and information relating to the middle load and base load of the power wholesaler. Next, the trading planning apparatus 1 executes phase Ph5 which pertains to today's trading based on information relating to negawatts in market B, information relating to commodity pre-market trading over one time frame and commodity future delivery over a four hour interval, in market A, aggregator-related information, and information relating to the middle load of the power wholesaler, executes phase Ph6 which is during delivery based on aggregator-related information and information relating to renewable energy of the power wholesaler, transmits the processing result to the consumer under contract, and subsequently executes trading settlement processing. Note that, in phase 6, the 30-minute commodity delivery period in the ancillary is during delivery. Furthermore, the period extending until trading settlement processing which includes the 30-minute commodity delivery period is a block trading delivery period.

### <<System Connective Relationships Diagram>>

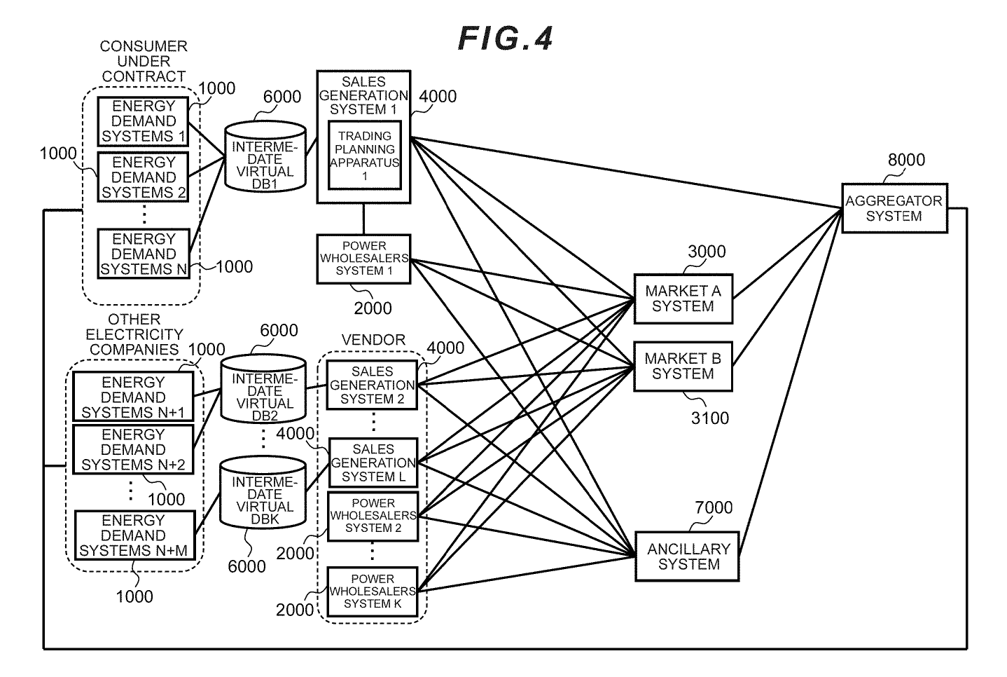

FIG. 4 is a connective relationships diagram which shows the connective relationships of the system according to this embodiment. In FIG. 4, the system according to this embodiment is configured from a plurality of demand systems (1 to N) 1000 which belong to a consumer under contract, a plurality of demand systems (N+1 to N+M) 1000 which belong to other consumers, a sales business system (1) 4000, a power generation business system (1) 2000, a plurality of sales business systems (2 to L) 4000 which belong to other electricity companies, a plurality of power generation business systems (2 to K) 2000 which belong to other electricity companies, a market A system 3000, a market B system 3100, an ancillary system 7000, and an aggregator system 8000, the systems each being connected via a network. The sales business system 4000 which is used by a power vendor comprises the trading planning apparatus 1. The sales business system 4000 receives the data from the demand systems 1000 via an intermediate virtual database (virtual database) 6000 for mediating the data managed by the power distributor. The sales business system 4000 also acquires data relating to supply from the power generation business system 2000 of the power wholesaler conducting the relative trade (data on the volumes of steam power that can be generated and controlled, and data on the power generation status of renewable energy from solar and wind power). Furthermore, the sales business system 4000 exchanges data relating to each market from the market A system 3000 and market B system 3100, and exchanges data relating to orders placed and accepted with the aggregator system 8000 which makes a demand response.

### <<Flowchart>>

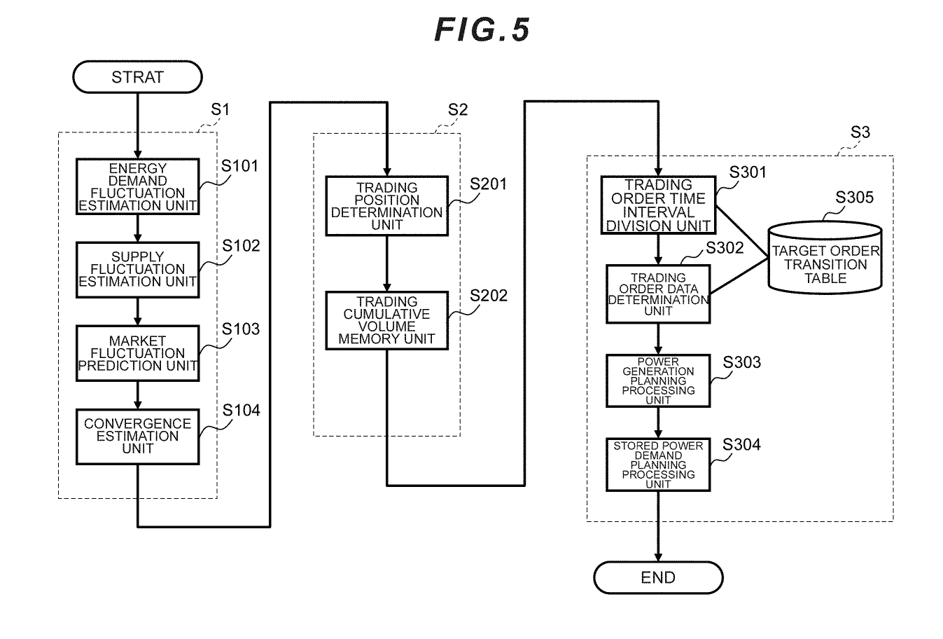

FIG. 5 is a flowchart showing the overall processing which is performed by the trading planning apparatus according to this embodiment. In FIG. 5, the future volume estimation unit 10 estimates various future volumes (step S1), the order volume planning unit 20 plans order volumes from the estimation result of the future volume estimation unit 10 (step S2), and the time interval-differentiated order planning unit 30 performs time interval-differentiated order planning based on the order volume planning and transmits the order data to the markets and clients based on the planning results (step S3). Details of the processing of each unit will be explained hereinbelow.

### [Processing of the Future Volume Estimation Unit 10]

(Step S101) The demand fluctuation estimation unit 101 estimates the future volume of demand for power which is consumed by the consumers supplying the power. Here, the demand fluctuation estimation unit 101 divides a future period into 30-minute unit periods and estimates the demand volume in each period. The estimation is performed based on previous demand results data. For example, the demand fluctuation estimation unit 101 may be configured to make a prediction by selecting a demand curve for weekdays, calendar days or days of similar demand when climate data is similar, generate a multiple regression prediction model for demand volumes such as daily maximum, daily minimum, daily mean or maximum and minimum demand volumes, predict daily maximum, daily minimum, daily mean or maximum and minimum demand volumes from weather forecast data, and amend the demand curve. Alternatively, the demand fluctuation estimation unit 101 may be configured to set the time interval fluctuations of previous demand as time series data and perform a time series prediction using an autoregressive model.

(Step S102) The supply fluctuation estimation unit 102 estimates the future volume of data relating to the power generation of a power wholesaler who supplies wholesale the power that the vendor supplies to the consumer. This processing includes processing to estimate the future volumes of the renewable energy supply volumes of solar power generation and wind power generation. The estimation is performed based on previous power generation results data. For example, the demand fluctuation estimation unit 101 may be configured to make a prediction by selecting a power generation curve for days of similar demand when climate data is similar, generate a multiple regression prediction model for power generation volumes such as daily maximum, daily minimum, daily mean or maximum and minimum power generation volumes from weather data, predict daily maximum, daily minimum, daily mean or maximum and minimum power generation volumes from weather forecast data, and amend the power generation curve. Alternatively, the demand fluctuation estimation unit 101 may be configured to set the time interval fluctuations of previous power generation as time series data and perform a time series prediction using an autoregressive model.

More preferably, the processing of the supply fluctuation estimation unit 102 of this embodiment includes processing for estimating, as data relating to power generation data, the future volumes of controllable volumes of steam power generation and pumped-power generation (the power generation volume that can be increased and the power generation volume that can be reduced within 30 minutes by issuing a control request).

(Step S103) The market fluctuation prediction unit 103 performs a future volume estimate of data for the market price of the wholesale market that provides the power which vendors supply to consumers, and for the bid quantity and bid power volume (the data in each case is treated as a continuous volume or discrete value volume). The estimation is performed based on previous market data. For example, the market fluctuation prediction unit 103 may be configured to make a prediction by selecting a price curve or bid quantity curve, and a bid power volume curve for weekdays, calendar days, or similar days when data for the weather, assumed demand volume or planned stoppage generator capacity is similar, generate a multiple regression prediction model relating to daily maximum, daily minimum, daily mean or maximum and minimum values for each curve, calculate each multiple regression predicted value based on assumed data for weekdays, calendar days, the weather, assumed demand volume, planned stoppage generator capacity, and minimum demand volumes from weather forecast data, and amend each curve. Alternatively, the market fluctuation prediction unit 103 may be configured to set the time interval fluctuations of previous data as time series data and perform a time series prediction using an autoregressive model.

Furthermore, more preferably, the market fluctuation prediction unit 103 of this embodiment comprises a future volume estimation unit which estimates the spare capacity of a power line pertaining to the distribution of power that is procured from a power plant, a future volume estimation unit which estimates the value and quantity of provisioned volume power generation rights that can be purchased by a power wholesaler (control reserve trading), a future volume estimation unit which estimates the price of ancillary services for eliminating a power wholesaler imbalance (services for supplying the difference between the supply volume and demand volume), a future volume estimation unit which estimates the future volume of negawatts trading, and a future volume estimation unit which estimates fuel (the LNG or crude oil market price or futures trade price), and the market fluctuation prediction unit 103 performs processing to estimate these future volumes. Consequently, a trading plan can be formulated which includes the provision of power distribution reservation rights and control reserve power generation rights, and the use of ancillary services and negawatts.

(Step S104) The convergence estimation unit 104 estimates calculation error transitions for each of the future volume estimation amounts. Here, the convergence estimation unit 104 divides a future period into 30-minute unit periods and estimates calculation errors in the estimation amounts in each period. The estimation is made based on previous results data. For example, the convergence estimation unit 104 sets time interval fluctuations of previous results data as time series data and performs a time series prediction using an autoregressive distributed lag model.

More preferably, the convergence estimation unit 104 may be configured to segment the previous results data into predetermined periods (of 24 hours, 48 hours, one week and so on, for example), convert each period using a fast Fourier or wavelet transform, perform classification on each of the periods having similar characteristic amounts of periodic fluctuation, extract a periodic fluctuation pattern (calculated by inversely transforming the average value of the characteristic amounts) for each classified group, generate a discrimination tree which discriminates conditions (attributes) for which the pattern is generated from attributes which are common to each of the classified groups (the weekday, calendar day, temperature, sunlight and other weather data, number of power generators for which stoppage is planned stoppage, spare distributed power capacity, and predicted demand value, and the like) by means of a CART, ID3 or other discrimination algorithm, estimates a plurality of candidates for patterns to be generated in the future periods from the discrimination tree, and determines a future volume frequency distribution which is generated by synthesizing the estimated patterns. As a result, for example, it is possible to adequately estimate future volume including irregular fluctuations known as market price spikes and implement a trading plan which takes spike generation into account (a trading plan which considers changes in the effective frontier to account for spikes).

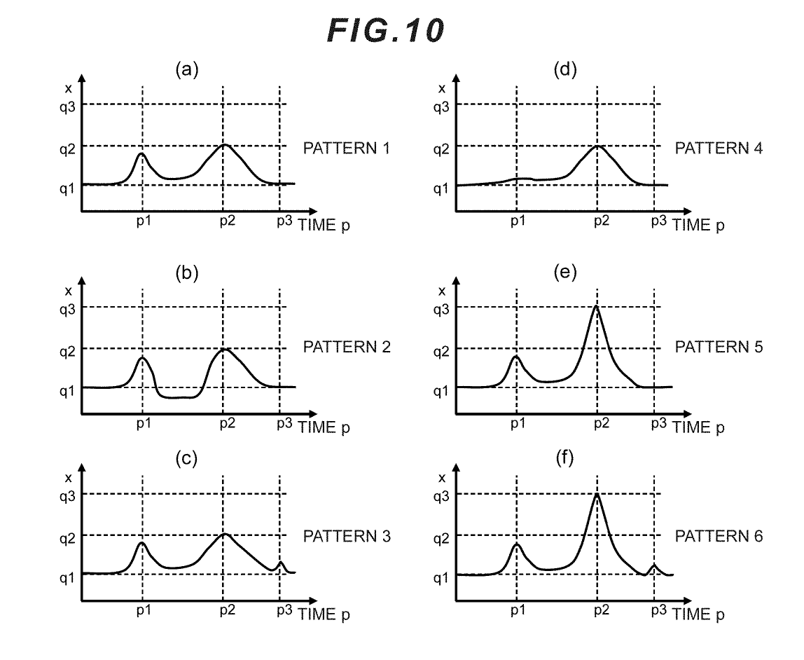

FIGS. 10A to 10F show examples of extracting patterns 1 to 6 for future volume time interval transitions in predetermined periods which are found as above.

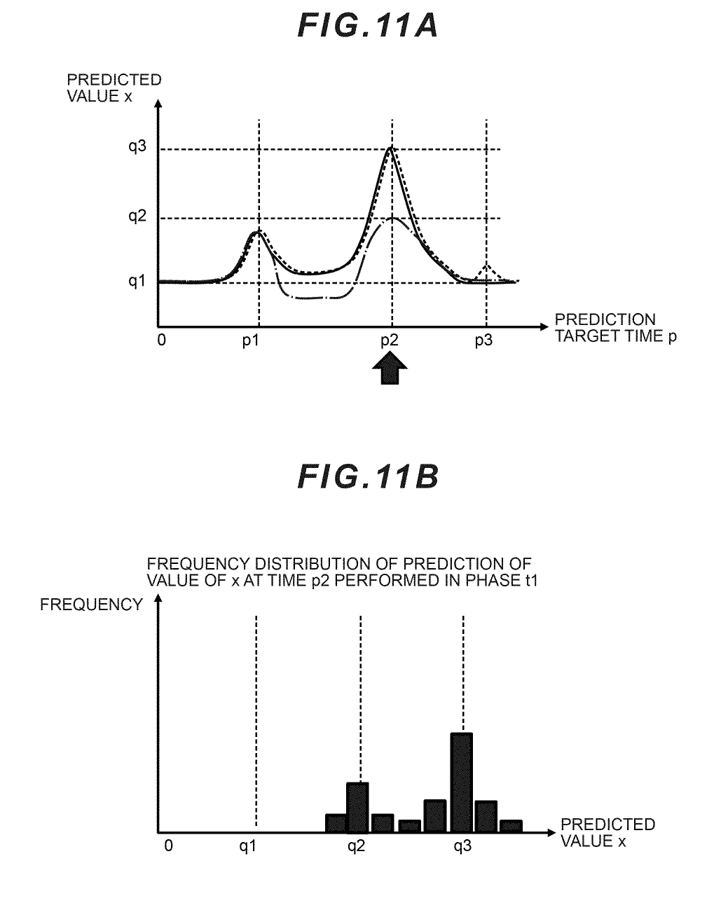

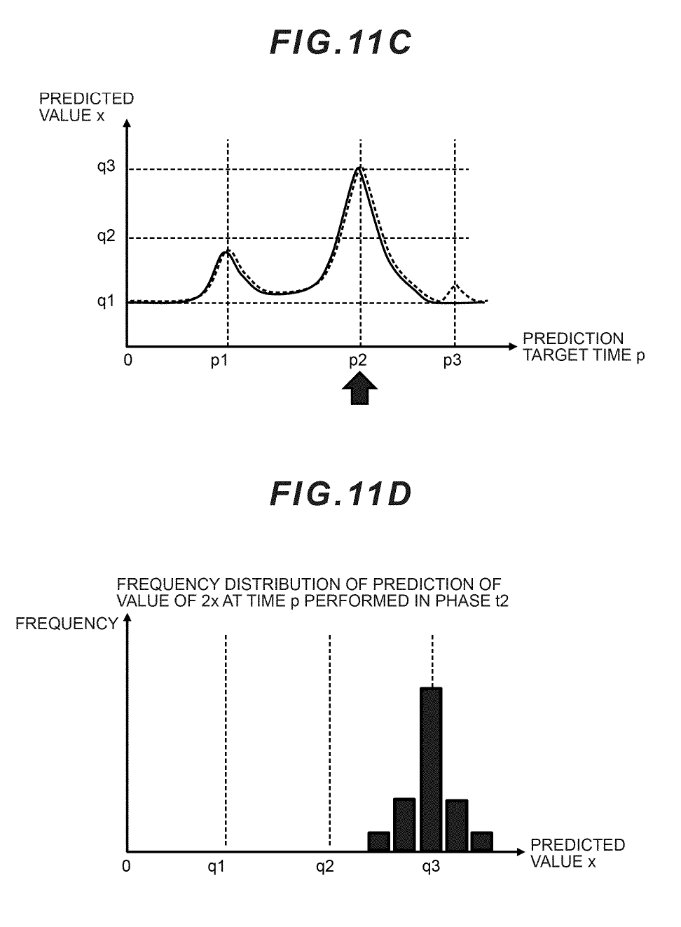

FIG. 11A is a diagram obtained by plotting candidate patterns for transitions in future volume (here, one example of demand volume) during a certain future period 0 to p3 (0:00 to 24:00 on July 3, for example) at a time t within a phase (power trading processing) Ph2 of the sequence in FIG. 3. Three patterns are output as candidates. FIG. 11B shows a frequency distribution of estimation amounts (prediction amounts) for future volume at a future time p2 in FIG. 11A, based on information on the probability of selecting each candidate pattern in FIG. 11A (the selection ratio in the discrimination tree) and the candidate patterns (or previous measurement data constituting a sample for generating candidate patterns). FIG. 11C is a diagram obtained by plotting candidate patterns for transitions in future volume (here, one example of demand volume) during the same future period (0:00 to 24:00 on July 3) at a time t2 in a phase (power trading processing) Ph4 of the sequence in FIG. 3. Two patterns are output as candidates. FIG. 11D shows a frequency distribution of estimation amounts (prediction amounts) for future volume at a future time p2, likewise based on information on the probability of selecting each candidate pattern in FIG. 11C (the selection ratio in the discrimination tree) and the candidate patterns (or previous measurement data constituting a sample for generating candidate patterns).

Here, as the timing for executing the estimation from time t1 of phase Ph2 to time t2 of phase Ph3 progresses, prediction calculation errors are reduced (the range of the frequency distribution narrows and the likelihood has risen).

Particularly preferably, in this embodiment, calculation error (variance value or likelihood) values are taken as time series data and changes (convergence) in these values may be predicted.

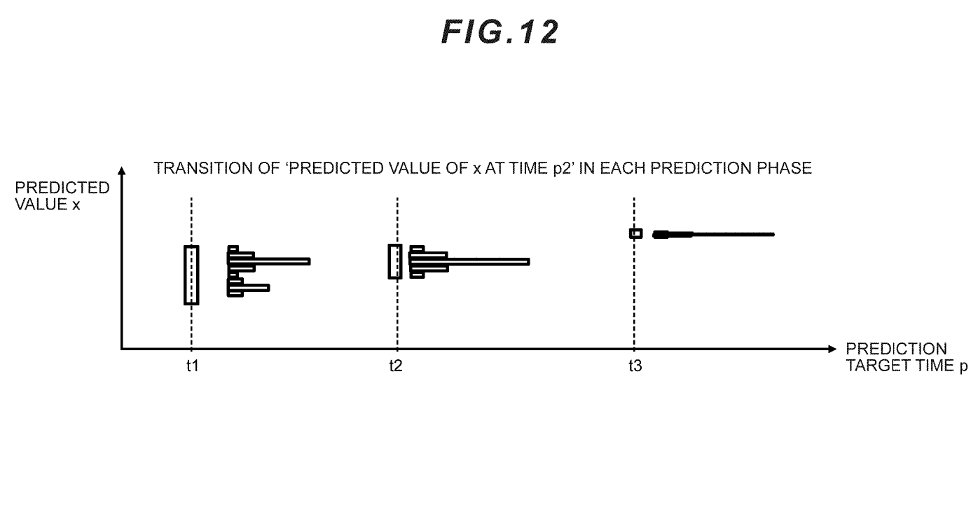

FIG. 12 is a diagram showing an example of measurement values for a predicted transition in each phase where future volume estimation (prediction) is performed (illustrated by a mountain-shaped frequency distribution), and values (illustrated by a box chart) as a result of estimating the predicted value transitions in the variance value (estimates using an autoregressive distributed lag model). In this embodiment, a predicted value transition of x at time p2 in each prediction phase is shown.

### [Processing of the Order Volume Planning Unit 20]

In the processing of the order volume planning unit 20 in steps S201 to S202, a determination of the order volume, supplier, and order commodity type of power provision required to supply power is made from estimates relating to demand, markets, and various forms of power generation that can be operated in-house under relative contract (steam power generation, water power generation, solar power generation) and from data on estimate calculation errors (variance or likelihood). The processing of the power generation volume planning unit 20 will be explained in detail hereinbelow.

(Step S201) The trading position determination unit 201 performs processing to determine a trading position which is a value for the volume (order volume, accepted volume) of a trade with a client in each 30-minute delivery time interval from trading cumulative volume and future volume estimation data which relates to demand and clients (wholesalers supplying wholesale, other companies and markets performing wholesale provision). A trading position is determined from a portfolio which are planned values for assigning managed funds. A portfolio is the proportions of managed funds assigned to a plurality of risk-free assets and risky assets. In this embodiment, a portfolio whose assets are taken to be power generation volumes agreed with a client power plant, and market-traded power commodities is planned. Here, an effective frontier (an effective, optimal portfolio, also called the efficient frontier) is a feasible portfolio which satisfies three conditions: (1) can be realized by satisfying supply volume constraints such as generator capacity and the physical constraints of the operation such as startup and shutdown time intervals, a minimum stoppage time interval and a minimum operating time interval, (2) a portfolio for which the evaluation value of the period earnings amount is maximum, and 3) the period earnings amount obtained is equal to or more than the period earnings amount of a portfolio with a smaller risk evaluation value.

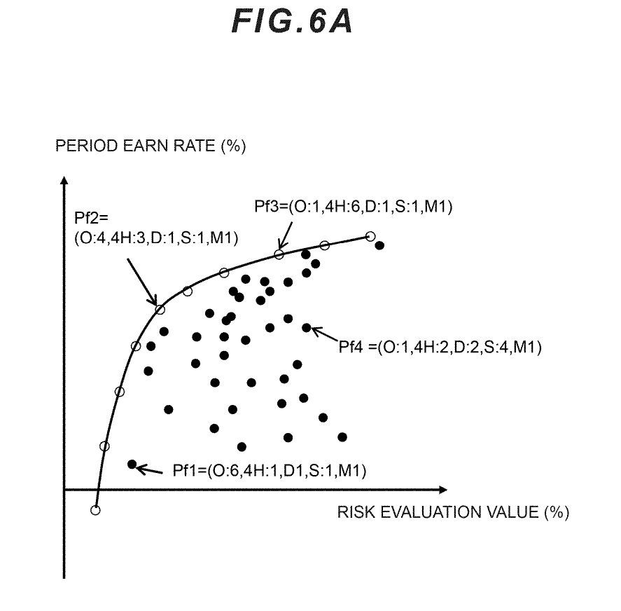

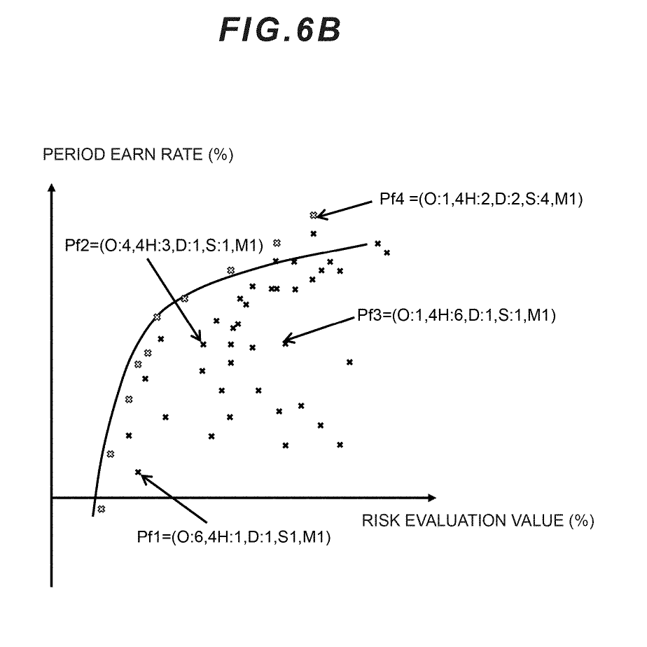

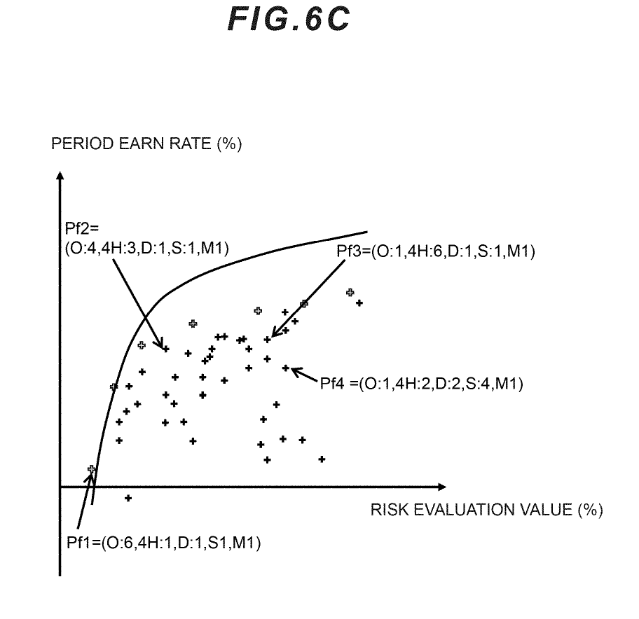

FIG. 6A is a graph relating to evaluation values for each feasible portfolio in the first half of phase Ph2 (10 days before delivery). Here, earnings evaluation values from a simulation of trade execution according to the portfolios are plotted on the vertical axis, while earnings VaR (Value at Risk) values in this simulation are plotted on the horizontal axis. The evaluation values for a feasible portfolio are obtained by implementing a Monte Carlo simulation in the simulation. Pf1, Pf2, Pf3 and Pf4 in FIG. 6A are each portfolios which have different trading commodity configurations (power generation configurations).

Note that the earnings evaluation period in this embodiment is taken to be one week which includes a delivery day when power is delivered to the consumer, and portfolios which satisfy feasible solutions among the physical constraints (the feasible solutions of a one-week generator start and stoppage plan and an output distribution) are evaluated.

Pf1 represents one portfolio in which, by means of a feasible solution obtained as trading in each 30-minute time frame, the ratios of an in-house contract generator, power generation in a 4-hour block, 30 minutes of power generation in the previous day's trading, 30 minutes of power generation in pre-market trading, and managed reserve funds, of the total supply volume in one day, are held in the ratios 6:1:1:1:1. Similarly, Pf2 has one day's managed funds assigned in the ratios 4:3:1:1:1, Pf3 in the ratios 1:6:1:1:1, and Pf4 in the ratios 1:2:2:4:1.

Note that, instead of this embodiment, it is also possible to hold portfolio data as power generation, sale and purchase-related distribution ratios in supplied kWh.

In the foregoing example of FIG. 6A, Pf2 and Pf3 are portfolios which satisfy the effective frontier condition in the phase Ph2 valuation. The evaluation result is output from the input/output interface 70, and a selection instruction to advance planning processing using either portfolio is received.

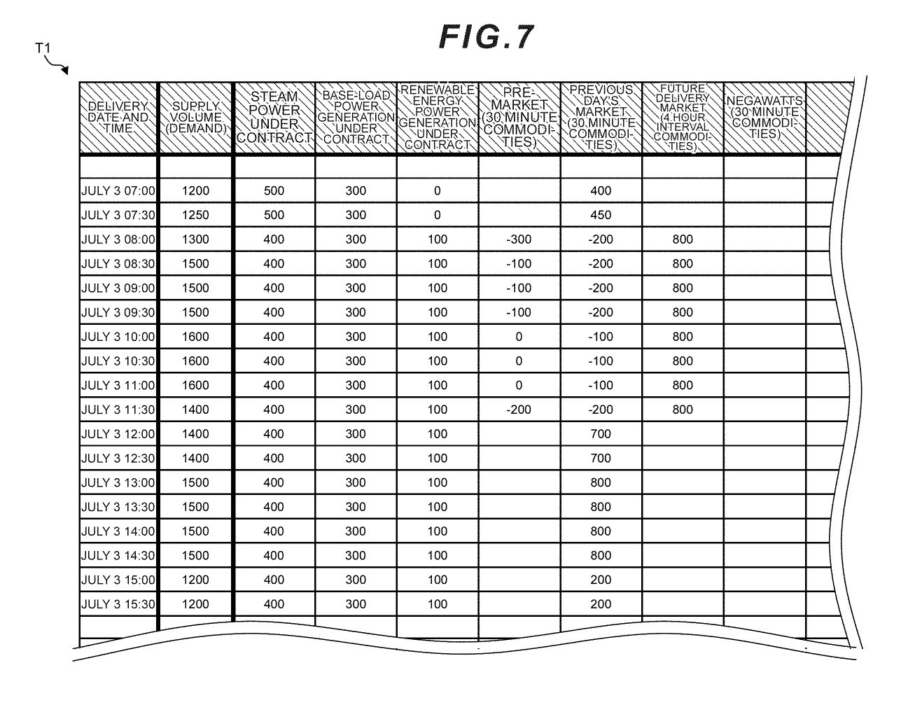

A trading position for every 30 minutes of implementing the portfolio for which the selection instruction was received is called from the foregoing simulation results and stored in the data table T1 of FIG. 7. The example of data table T1 shows the results of a plan to purchase commodities at wholesale in a four-hour block and sell commodities at wholesale in one 30-minute time frame. Note that the volume of sales at wholesale is stored as a negative value.

In this embodiment, a simulation which includes an evaluation value which is a negative value is optionally conducted. This means that a sell bid is tendered to the market. In the example of data table T1 in FIG. 7, for delivery starting at 8:00 and ending at 12:00 (11:30 start time frame), planning results are shown in which, because demand exceeds the scheduled shared power generation by a contract power plant and the kW obtained as a result of provision in a four hour block, power is sold at wholesale in the previous day's market and pre-market as a 30-minute power commodity. The trading positions every 30 minutes that are thus determined are output (step S201 hereinabove).

(Step S202) For the trading positions, the trading cumulative volume storage unit 202 receives and records cumulative data for trading under market contract and results data for plan agreements with client wholesalers and aggregator companies which supply negawatts. The recording result passes through the input/output interface 70 before being output to the user.

The foregoing is processing of the order volume planning unit 20. As a result of this processing, a target value for the power volume which is provisioned from the client for the supply time interval, is determined for each delivery time zone (each delivery time frame) as tagged data specifying the commodity type, client and power generation type.

[Processing of the Order Volume Planning Unit 20, Reprocessing for Repetitive in-Phase Execution]

In this embodiment, steps S201 and S202 are executed repeatedly in phases Ph1 to Ph6 shown in FIG. 3 (and are also executed for each predetermined period (of two hours, for example) in one phase). As a result, trading planning for trading between clients and markets in which a plurality of trades of different trading periods are conducted, and trading planning which corresponds to changes in demand and client status, based on data on real demand, status, and power generator operating states, which gradually become clear, can be performed.

For example, as a result of executing the processing in phase Ph3 (step S201), the portfolio evaluation differs from the aforementioned portfolio evaluation in phase Ph2 (explained in FIG. 6A above), and the portfolios in FIG. 6B are calculated in the same way as the processing of step S201 above based on newly received data.

Here, in step S201, when the effective frontier for selecting portfolios is the same as that executed on the previous occasion, processing changes are not made. The processing is characterized in that, when the effective frontier differs from that executed on the previous occasion (when, for example, there are differences between FIGS. 6A and 6B), processing is carried out to change portfolio selection.

Note that, in the example shown in FIG. 6B of the embodiment, weather forecast data for delivery day, four days before delivery in phase Ph3, has changed from ‘cloudy’ to ‘cloudy with sunny spells, high winds.’

Changes in the market-related future volume estimation amount arise because of the generation of a market price drop due to ‘the supply of renewable energy from sunlight increasing and wholesalers for whom a supply capability surplus has been generated bringing about an increase in sell bids in 30-minute commodity pre-market trading for steam power generation, and because there is an increase in the market price variance value due to an increase in bids on renewable energy which is highly weather-dependent.’ Based on the estimation amounts pertaining to the new market, the portfolio which satisfies the condition qualifying a portfolio as an effective frontier portfolio is the aforementioned Pf4.

Furthermore, in the example shown in FIG. 6C of this embodiment, weather forecast data for delivery day, four days before delivery in phase Ph3, has changed from ‘cloudy’ to ‘rainy’ (a lot of moderate cloud).’

Future volume estimates are each updated by reflecting the fact that ‘there is an increase in market price due to the supply of renewable energy from sunlight decreasing and wholesalers for whom a supply capability surplus has been diminished reducing sell bids for the 30-minute spot price, and there is an increase in the market price variance value owing to an increased frequency of occurrence of a phenomenon whereby there is a larger buy position in the wholesale market and the generation of market segmentation due to confusion over power flow resulting from an increased deviation in power generation locations.’ Based on the estimation amounts pertaining to the new market, the portfolio which satisfies the condition qualifying a portfolio as an effective frontier portfolio is the aforementioned Pf1.

In a preferred embodiment of the present invention, the portfolio evaluation result outputs current and future evaluation values for the portfolio which are estimated from calculation error estimation data in a convergence estimation. Furthermore, an effective frontier simulation result at each time (and in each phase of FIG. 3) could also be output.

By outputting, via outputs of the input/output interface for selecting portfolios, a current evaluation of a portfolio (power generation composition ratios or power commodity provision composition ratios) and portfolio evaluations which are generated in future phases (the generation of the effective frontier in FIG. 6B or 6C due to changes in the weather is forecast from the effective frontier of FIG. 6A), an earnings reduction is displayed and a warning issued to the user for phase Ph6 in which 60% of managed funds are assigned to future delivery power, in an evaluation based on weather data derived from assumed weather changes.

In this embodiment, when, in step S201, the total of the trading volumes for all clients differs from the future demand volume by a margin of a predetermined value or more, the trade quantity of any client is preferably increased or reduced.

Furthermore, update processing is performed so that, when an estimate for the trade price of a certain client is lower than the trade price pertaining to the cumulative trading volume of all trades, the trading volume assigned to the client is increased, and when the estimate for the trade price of a certain client is higher, the trading volume assigned to the client is reduced.

Moreover, update processing is performed to reduce the trading volume assigned to clients for whom the value of data relating to trade price calculation errors has increased for each client, and to increase the trading volume assigned to clients for whom calculation error-related data has decreased.

Furthermore, a trading combination is calculated based on the effective frontier calculated from expected earnings from trading and the expected earnings risk, and the effective frontier of a latter trading period is calculated from data in a range in which expected future earnings change or an expected earnings variance changes in the latter period of the trading period, and a combination of trades with a plurality of clients is determined to enable a change from a portfolio (ratios of sales for the provision of power generation and electric power commodities) which is close to the effective frontier to a portfolio close to the latter period effective frontier. Alternatively, a combination of trades with a plurality of clients is determined based on data for points of intersection between the effective frontier and the latter period effective frontier, or data for points which have a predetermined proximity to the points of intersection. An effective plan can be obtained both when various fluctuations occur and when no fluctuations occur by determining a trading position from a portfolio which is close to the points of intersection in particular. For example, in a trading plan for a supply day when there will likely be extreme fluctuations in market price, for example, an effective trading plan can be implemented irrespective of whether there have been market price fluctuations.

### [Processing of the Time Interval-Differentiated Order Planning Unit 30]

In the processing of the time interval-differentiated order planning unit 30 in steps S301 to S304, trading order data relating to client order placement and acceptance instructions is generated in a trading period in which power trading takes place between clients and markets and so on (the supply of power is provided to consumers successively or continuously, and therefore the trading period is divided into time zones of predetermined intervals (of 30 minutes or 4 hours, for example), and trading of the power generation and negawatts which are provided for the supply of power in each of the time zones is executed such that predetermined periods before the actual power supply time zones serve as the trading periods (for example, from 17:00 on the day before delivery until one hour before the delivery time interval, from 48 hours before until 24 hours before, from 24 hours before until 1 hour before, and from 10 days before until 3 days before). Orders are placed in stages in a plurality of planned trading periods obtained by segmenting a trading period, and an economical order plan can be obtained which corresponds to market price fluctuations and so on during the trading period. Details of the processing of steps S301 to S304 are provided hereinbelow.

(Step S301) The trading order time interval division unit 301 receives values of the aforementioned trading position and divides the quantity of trades of a commodity (a contracted power volume (kW)) into equal amounts for the position as the target volume for provision of the commodity (the complete position) for each client and market in the trading period.

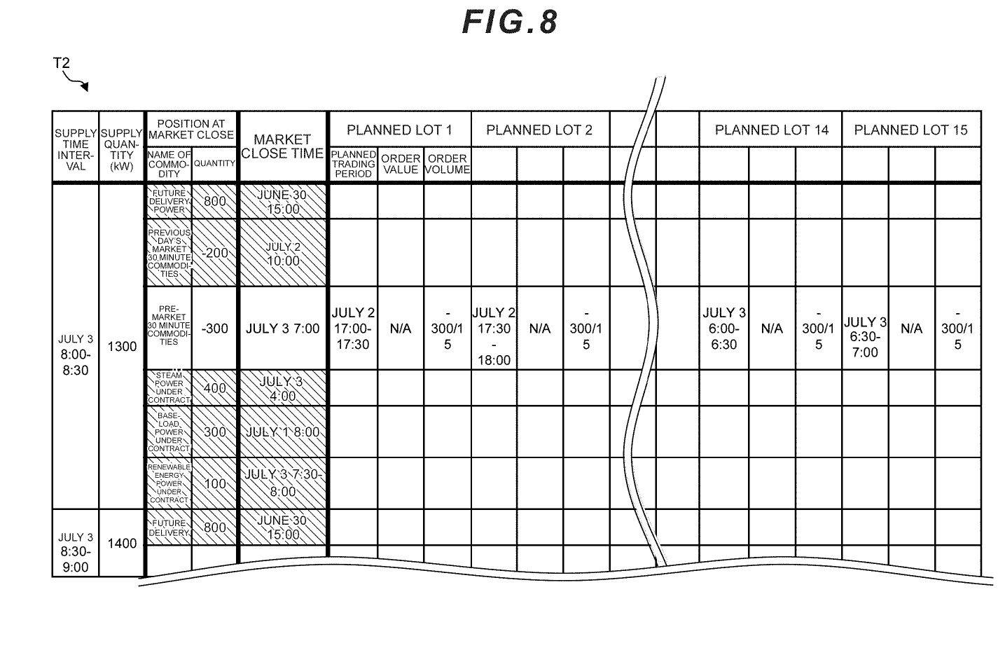

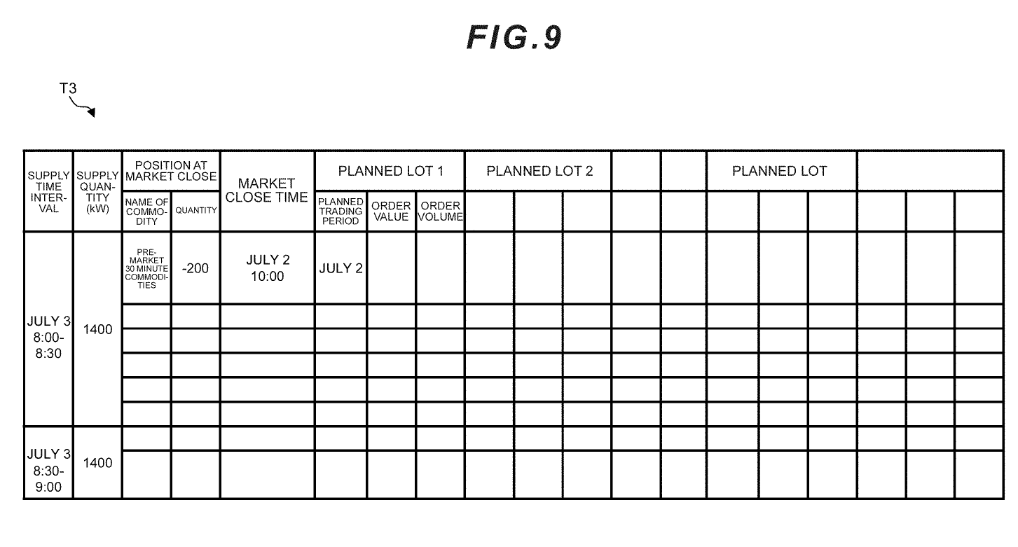

The divided values are stored in the target order transition table T2 shown in FIG. 8 or the target order transition table T3 shown in FIG. 9. The target order transition table T2 shown in FIG. 8 shows an example of data for a 30-minute commodity which is sold wholesale in pre-market trading. A final time of 7:00 on July 3 and a final position of −300 kW (a position where 300 kW are sold is shown) are taken as targets, and in each planned lot obtained by dividing the complete position by 15, trade execution equating to (−300/15) kW is regarded as the target value. Note that, in the example of FIG. 8, the trading period is segmented into planned trading periods of 30 minutes each, but the planned trading periods are not limited to this time interval, rather, the planned trading periods could also be 10-minute periods or longer, two-hour periods, for example. The segmented order units are also called planned lots. Planned lots may also be created for each power commodity. As a result, trading planning and trading results management can be made more efficient by extending the planned trading period for commodities with a small number of bids and shortening the planned trading period for commodities with a high number of bids.

Instead of this embodiment, trading funds may also be divided into equal amounts. Furthermore, the trade quantity and the weighted sum of trade quantity variance values may also be divided into equal amounts. Moreover, trading funds and the weighted sum of trading funds variance values may also be divided into equal amounts.

More preferably, where order placement in the planned trading periods obtained by segmenting the trading period is concerned, the value of order data for each planned trading period can be amended by being increased or reduced depending on the scale of the calculation error in the future volume estimation which is the value of the convergence estimation pertaining to the planned trading period. As a result, preference can be given to planned trading periods with few calculation errors, and a trading plan with more stable implementation of the targeted trade quantity and trading earnings can be carried out.

Still more preferably, each divergence in the effective frontier (or trading position) at each time point of the trading period, as calculated in step 201, is calculated (for example, the center distance of the points (portfolio) contained in an effective frontier set), and if the divergence is large, processing to reduce the trade quantity of the planned trading period to achieve the future value is implemented. Consequently, it is possible to obtain a trading result that avoids a situation where the configuration for provisioning power generation and power commodities cannot be changed when the effective frontier varies in the latter period of the trading plan, and where uneconomical trading occurs.

(Step S302) Where order placement in a planned trading period is concerned, the trading order data determination unit 302 performs processing to refer to the target order transition table T2, determine the value of trading order data for provisioning a market commodity in the planned trading period, and send the data to the market order terminal 5000. When a target value M for the contracted trade quantity is given, the trading order data determination unit 302 generates price data X and bid quantity O data as per (Equation 1).

X=f(R,P,σ),O=M/R [Equation 1]

Here, M is a variable for designating the bid quantity (the power volume of the position), R is a variable for designating a target contract ratio, and P and a are variables indicating market conditions, where P is the expected value of the trade price and a is a variable representing a trading value variance. Function f is a function which refers to a table (for example, a t distribution table) representing the statistical properties pertaining to the market, and provides a price X for executing a trade in a ratio R from a confidence interval which determines the price at which a trade can be closed (executed) from a contract price distribution (for example, when the confidence interval for execution at 95% is (P±1σ), if a purchase is made and a price P+σ is designated, execution of 95% can be expected in this period). R is a value of 0.1 to 0.9, for example, which substitutes the value that is designated by the user via the input/output interface.

(Step S303) The power generation planning processing unit 303 performs processing to simulate a power generation operation plan which is known as a load distribution plan and a generator start and stoppage plan for a power wholesaler under contract. Upon obtaining an operation capability result from the simulation, the power generation planning processing unit 303 sends data to the power generation order terminal 5100. When an inoperable simulation result is output, the power generation planning processing unit 303 outputs an alert display to the input/output interface 70.

(Step S304) The stored power demand planning processing unit 304 performs processing to simulate a brownout plan for a DR aggregator under contract. Upon obtaining an operable result from the simulation, the power generation planning processing unit 303 sends data to the aggregator order terminal 5200. When an inoperable simulation result is output, the power generation planning processing unit 303 outputs an alert display to the input/output interface 70.

### Effects of the Embodiment

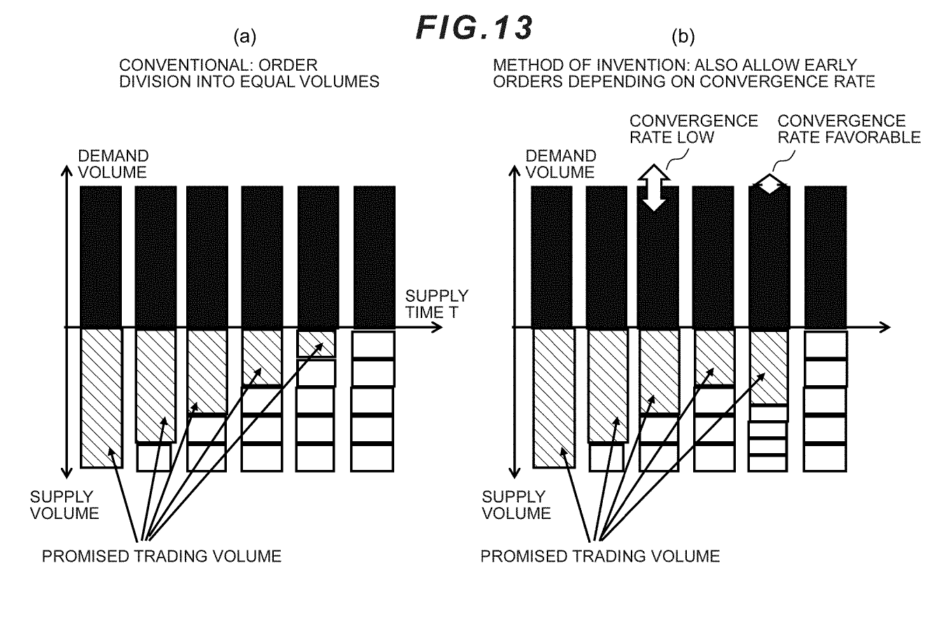

FIG. 13 shows order results when the trading plan disclosed in the embodiment of the present invention has been implemented and when same has not been implemented. FIG. 13A is a conventional example in which the order has been divided into equal quantities. FIG. 13B shows a result obtained by means of order placement by the trading planning apparatus 1 of the present invention. By using the trading planning apparatus 1, an early order option is provided at times when there are no demand calculation errors (in delivery time frames, delivery time intervals), whereby an inexpensive supply capability is made available and early order placement is also approved according to a convergence rate. Note that the same is true for the price convergence rate and solar power generation convergence rate at times when there are no demand calculation errors, but not for the demand volume.

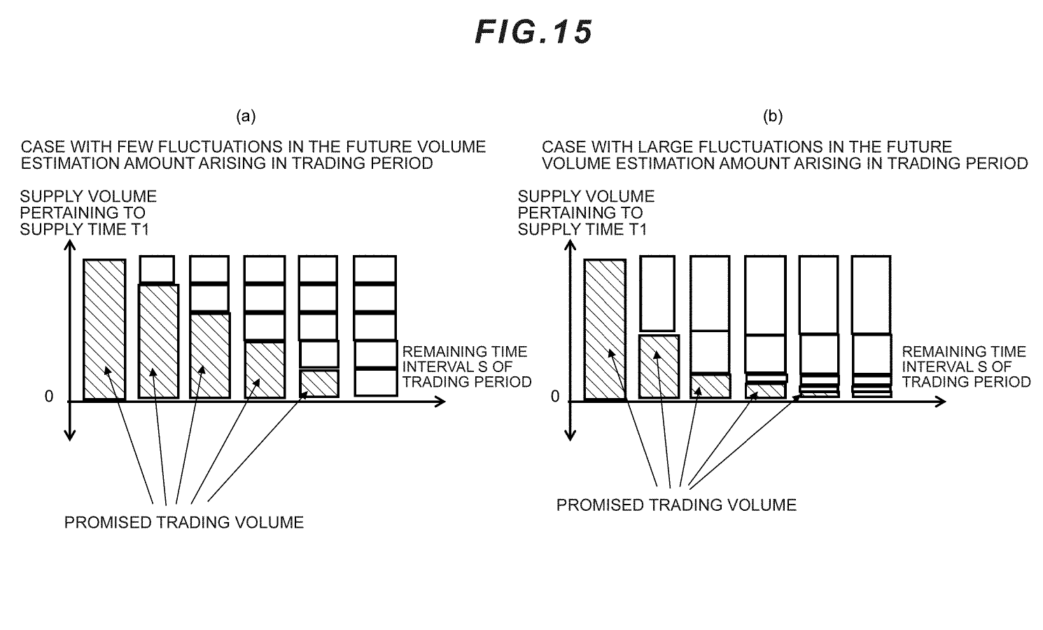

FIG. 15 shows power commodities in supply time interval T1 and transitions in power generation order results when the trading planning disclosed in the embodiment of the present invention has been implemented. FIG. 15A shows contract volumes and noncontract volumes as a result of order placement in a case with few fluctuations in the future volume estimation amount arising in the trading period. The noncontract volumes increase in proportion to the remaining trading time interval (contract volumes decrease).

FIG. 15B shows contract volumes and noncontract volumes as a result of order placement in a case with large fluctuations in the future volume estimation amount arising in the trading period. The noncontract volumes increase exponentially with the remaining trading time interval (contract volumes increase). This depends on whether there has been a backlog in orders in view of uncertain future conditions and the size of demand (the size of fluctuations in the future volume estimation amount).

Note that obtaining a contract involves establishing a purchase or sale for a bid (telegram transmission) in the marketplace (also called the market), gaining consent for a power delivery proposal from a power wholesaler or negawatts supply business (aggregator) or the like, or gaining consent for a business transaction. proposal.

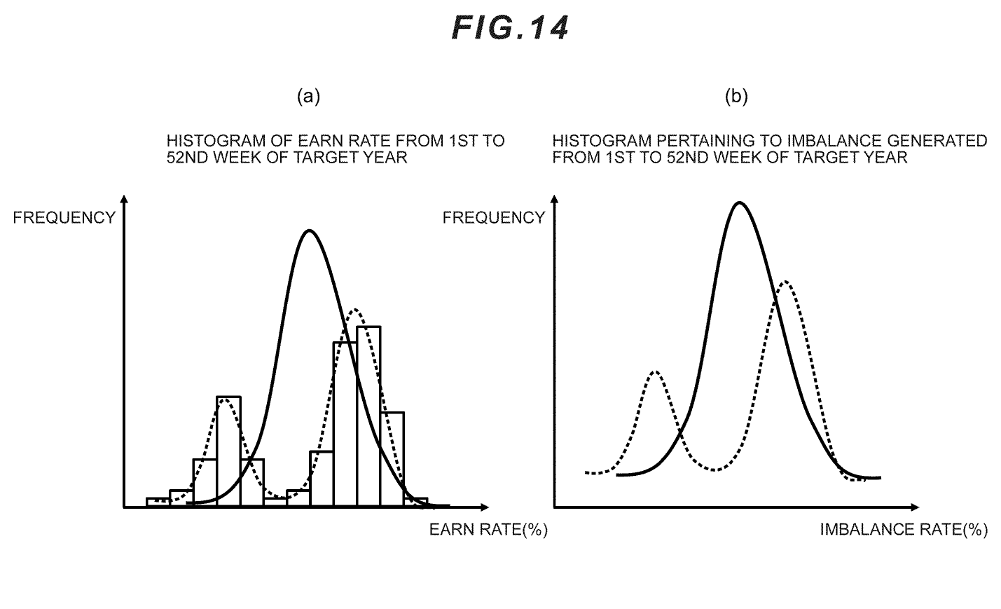

FIG. 14 shows examples of results (a) for vendor earnings when the trading planning of the embodiment of the present invention has been implemented and when same has not been implemented, and results (b) when a discrepancy (volume imbalance) arises between the demand volume and supply volume. FIG. 14A shows a histogram of the earn rate from the 1st to 52nd weeks of the target year, and FIG. 14B shows a histogram relating to an imbalance which arises in the 1st to 52nd weeks of the target year. The dotted lines indicate the results using conventional order equalization and the solid lines indicate results using the trading planning according to the embodiment of the present invention.

Conventionally (dotted lines), the generation of multipeak calculation errors like those in FIG. 11B and relating to demand and market price prediction have not been considered, and because fixed order placement is performed, starting with an initial overall trading stage, the earnings and volume imbalance are also scattered over a wide range at the multiple peaks. With the trading planning according to the embodiment of the present invention, earnings and volume imbalance calculation errors are reduced.

According to this embodiment, trading planning which is matched to market trends, demand fluctuations and client operating states is executed, thus making it possible to determine order placement volumes for clients and markets and determine order timing.

### <<Second Embodiment>> <Modification Example: Time Interval Arbitration>>

The trading planning apparatus 1 of this embodiment comprises the future volume estimation unit 10 which comprises a demand control volume estimation unit that generates data estimation amounts for volumes or time intervals relating to changes in demand generation; and the order volume planning unit 20 which comprises a demand control limitation unit which adds or subtracts data of trading positions (values of trading positions with different delivery time intervals) based on the values of demand limitation amounts.

As a result of this trading planning, trading planning which considers how demand is guided by demand response, stored power controls, and the like, can be implemented.

Furthermore, demand during inexpensive time intervals is increased (energy storage and so on) and demand during expensive time intervals is reduced. However, the volumes that can be traded can be limited to volumes which can be charged and discharged by storage cells, and to shift time zones.

### <<Third Embodiment>> <Modification Example: Reserve Trading of Power Distribution Rights

The trading planning apparatus 1 of this embodiment comprises the future volume estimation unit 10 which comprises a supply estimation unit that estimates the future volume of the supply of renewable energy power generation and a demand estimation unit that estimates the future volume of the demand volume of a consumer under contract; and the order volume planning unit 20 which comprises the trading position determination unit 201 that performs power generation sales according to the amount by which the renewable energy volume power generation volume exceeds the demand volume.

As a result of this trading planning, trading planning which enables the power generation thus created to contribute to supply can be implemented.

Moreover, the trading planning apparatus 1 of this embodiment comprises the future volume estimation unit 20 which comprises an estimation unit that estimates the future volume of spare capacity of power lines and interconnected power lines; and the time interval-differentiated order planning unit 30 which comprises a power line usage planning unit that creates a power line usage plan.

As a result of this trading planning, trading planning can be implemented which makes it possible to avoid work to stop the generation of renewable energy as a result of power line saturation, and which enables the power generation thus created to contribute to supply via power lines and interconnected lines. Consequently, trading which also reflects the economic value of reducing the embedded costs involved in stopping renewable energy is achieved.

### <<Fourth Embodiment>> <<Control Reserve Trading>>

The trading planning apparatus 1 of this embodiment comprises the future volume estimation unit 10 which comprises an estimation unit that estimates estimation amounts for future volume relating to control reserve trading (for example, estimation amounts for the price of a control reserve trade, and a trade quantity); and the order volume planning unit 20 which comprises the trading position determination unit 201 that determines control reserve provision volume, updates data relating to the demand volume according to the control reserve provision volume, and calculates a trading position.

As a result of this trading planning, trading planning which arranges provision when externally required to do so and which includes trading relating to control reserve for which buyback is difficult.

Furthermore, the trading planning apparatus 1 of this embodiment is also capable of calculating values of a convergence estimation which estimates estimation amounts for data relating to future volume calculation errors which are estimated from result values (for example, variance or likelihood values) and performing order volume planning or time interval division planning.

The above explanation can be summarized as follows, for example.

(1) A management apparatus according to one embodiment comprises an order volume planning unit which comprises a trading position determination unit that receives trading cumulative volume and estimation data for future volume relating to demand and clients and determines trading volumes of a plurality of clients.

As a result, trading planning that corresponds to an ever-changing future volume can be implemented.

(2) The order volume planning unit of the management apparatus in (1) above comprises a data table which enables positive and negative values to be collected as data relating to each of a plurality of trades.

As a result, sales trades and purchase trades can be executed at the same time for commodities which have the same delivery period (delivery date and period in which services are continuously provided). More preferably, it is possible to promote efficient energy usage by purchasing energy delivered over several time intervals via wholesale trading according to peak supply and sell and provide the supply surplus generated outside the peak supply time zones in wholesale trading.

(3) A management apparatus according to one embodiment comprises a time interval-differentiated order planning unit which comprises a trading order data determination unit that generates trading order data including data on order prices (for example, purchase bid prices, sell bid prices) or order quantities which relates to trading orders in the planned trading periods which are segmented periods over the course of the trading period when trading is possible.

As a result, efficient trading planning can be implemented in each time interval segment of the trading period.

(4) A management apparatus according to one embodiment comprises a future volume estimation unit which comprises a convergence estimation unit that estimates estimation amounts for data relating to future volume calculation errors which are estimated from result values (for example, variance or likelihood values).

As a result, trading planning that corresponds to a status indicating whether future volume estimation accuracy is favorable or poor (for example, order volume planning, and time interval division planning in order processing) can be implemented.

(5) An order volume planning unit of a management apparatus according to one embodiment comprises a trading position determination unit, wherein, when the total trading volume with all clients and the future demand volume differ by a margin of a predetermined value or more, the trade quantity of any client is increased or reduced (based on an estimate for the price of trading with each client or the quantity of trades that can be made).

(6) More preferably, the trading position determination unit is configured such that, when an estimate for the trade price of a certain client is lower than the trade price pertaining to the cumulative trading volume of all trades, the trading volume assigned to the client is increased, and when the estimate for the trade price of a certain client is higher, the trading volume assigned to the client is reduced.

(7) More preferably, the trading position determination unit reduces the trading volume assigned to clients for whom the value of data relating to trade price calculation errors (variance or likelihood) has increased for each client and increases the trading volume assigned to clients for whom calculation error-related data has decreased.

As a result, order placement which is tied to demand can be implemented based on economic reasonableness. More preferably, it is possible to implement order placement in which loss, which may arise due to various future volume fluctuations, can also be reduced.

(8) The order volume planning unit of the management apparatus according to one embodiment comprises a trading position determination unit which calculates a trading combination based on the effective frontier calculated from expected earnings from trading and the expected earnings risk (for example, the variance value of the expected earnings), calculates the effective frontier of a latter trading period from data in a range in which expected future earnings change or an expected earnings variance changes in the latter period of the trading period, and determines a combination of trades with a plurality of clients to enable a change from a portfolio (ratios of sales for the provision of power generation and electric power commodities) which is close to the effective frontier to a portfolio close to the latter period effective frontier.

As a result, in a case where a difference is anticipated in future volume-related estimations (for example, a demand volume of that day's time interval for supply, an estimation amount for the market trade price in trading relating to that time interval, and an estimation amount (convergence estimation amount) for the variance value thereof) between an initial estimation and a latter-period estimation, trading can be performed throughout the whole trading period even when the targeted planning result changes from an optimal trading planning result at an initial point in time to an optimal trading planning result at a latter-period time.

Still more preferably, the larger the evaluation value of the time interval that elapses in the convergence of future volume-related estimates, the more the order deadline is delayed.

As a result, even when there is a large amount of change in the latter-period effective frontier, the most highly economical trading according to the portfolio can be executed.

(9) A management apparatus according to one embodiment comprises a time interval-differentiated order planning unit which comprises a trading order time interval division unit that divides an order volume for each client into target values relating to order time interval transitions during a trading time interval.

As a result, even when a future volume estimate cannot be determined, by successively changing a client order volume, it is possible to implement trading planning which efficiently secures the order quantity that ultimately contributes toward the supply to the customer by the company.

(10) More preferably, where order placement in the planned trading periods obtained by segmenting the trading period is concerned, the management apparatus of the present invention comprises a time interval-differentiated trading planning unit which increases or reduces the value of order data in each planned trading period depending on the scale of the calculation error (variance or likelihood) in the future volume estimation pertaining to the planned trading period.

As a result, preference can be given to trading with few calculation errors, and a trading plan with more stable implementation of the targeted trade quantity and trading earnings can be carried out.

(11) The management apparatus according to one embodiment preferably comprises a time interval-differentiated order planning unit which comprises a trading order data determination unit that generates target trade quantity data (for example, the commodity trading order period, which is a trading period from 48 hours before the delivery time interval until 24 hours before the delivery time interval, is divided up, planned trading periods of 10 minutes each are configured, and a target value for all the trade quantities to be completed in each trading period is configured) for each planned trading period of a predetermined interval which was generated based on target order transition data, and creates trading order data which includes estimated trade prices and estimated trade price calculation error-weighted prices, according to the difference between the target trade quantity and the trade quantity results.

As a result, trading planning in which trading in the required quantity of trades is completed can be implemented.

For example, a determination of the bid price is made using this method when a trade quantity to be provisioned or sold is to be secured by market close. When a provisioning quantity is collected as a buyer, the bid price can be determined in bidding by using this method as follows. Bids can be accepted with a probability of 95% when a bid to purchase is made by setting the bid price at a value P+σ(P), where P is the expected price P and a is the variance, and the bid price for securing a contract for the required quantity is determined based on the statistical trend that a bid will be accepted with a 95% probability when the bid is made using the value P−σ(P). Still more preferably, the bid price is given a low value at an initial trading stage when the contract quantity may be small, and can be suitably changed to a high value such as the bid price P+σ at a stage where the trade quantity is required. In addition, in the case of a power generation seller, the value of the bid price is raised at times when there can be a small contract quantity, and when it is desirable for power generation subject to generator stoppage limitations to sell out, the bid price can be suitably changed to a lower value such as P−σ so that bids are more readily accepted.

(12) A management apparatus according to one embodiment comprises a trading order data determination unit which generates data relating to funds for trading in a planned trading period of a predetermined interval based on future volume estimation data and creates trading order data.

The management apparatus preferably comprises a time interval-differentiated order planning unit which comprises a trading order data determination unit that generates trading order data from trade funds data which is obtained by adding or subtracting a value, found by multiplying an estimation amount for the future volume estimation amount calculation error by a coefficient, to/from the foregoing trade funds.

As a result, even when there are fluctuations in the future volume over the course of the trading period (for example, trade price fluctuations and demand volume fluctuations), trading planning which does not lead to excessive payment funds because of the trade cost leveling effect can be implemented.

Still more preferably, funds for trading in planned trading periods of predetermined intervals are subject to planning so that trade funds after risk allocation (whose value is obtained by subtracting a value, given by multiplying the variance value p by a coefficient, from the expected trade funds Q) are equalized. As a result of this trading planning, trading planning, in which available funds are increased when the calculation errors for the estimation amounts of trade price and quantity are small and trade funds are reduced when calculation errors are large (market risk is high), can be implemented, thereby enabling efficient trading to be performed irrespective of market risk.

(13) The management apparatus according to one embodiment comprises an order volume planning unit which determines a trading position in a range limited by a reverse position that limits the purchase order volume and sale order volume of commodities with overlapping delivery time intervals (supply time intervals) (whose real supply is consequently offset).

By implementing such order volume limits, trading that matches real supply can be planned instead of trading volumes being increased without limitation.

For example, arbitrage and suitable volumes thereof can be determined when clients and trade markets differ. When a state arises where the same power commodities (for example, power commodities which are used for supply in the same time zone) are different and adopt different price values in the market (one product, two prices), and arbitrage which involves provision in an inexpensive market and selling in an expensive market is performed, if such arbitrage is implemented without an upper limit, the losses that can be realized when the predicted price is off the mark are a problem and hinder business operations; however, with the trading planning of the present invention, trading planning which limits the realizable losses to a permissible range can be implemented.

For example, in trading where power generation in a four-hour block is purchased and the 30-minute spot is sold (a straddle), the upper limit of the reverse position is limited by the straddle so that the trading volume does not increase without an upper limit. An evaluation which uses profits after risk allocation is performed, for example. Alternatively, an upper limit of a predetermined value is configured, or an upper limit for which a predetermined N multiple is taken as an upper trading limit for real supply is configured.

(14) A management apparatus according to one embodiment comprises a trading order data determination unit which calculates a weighted addition value for data of a price in a trading period (for example, an end value and a weighted average cost of capital (WACC) in the market trade) and data relating to convergence (including the variance value and convergence speed of the variance value), compares the relationship between a market seller's bid value and size, and generates trading order data.

As a result of this trading planning, trading planning can be implemented which has overall reasonableness in buying commodities urgently required by other companies at a high price and responding quickly to offers (bids) from an electric power interchange for remaining commodities at low cost, via the market, and economic reasonableness from the perspective of traders and so on.

### Fifth Embodiment

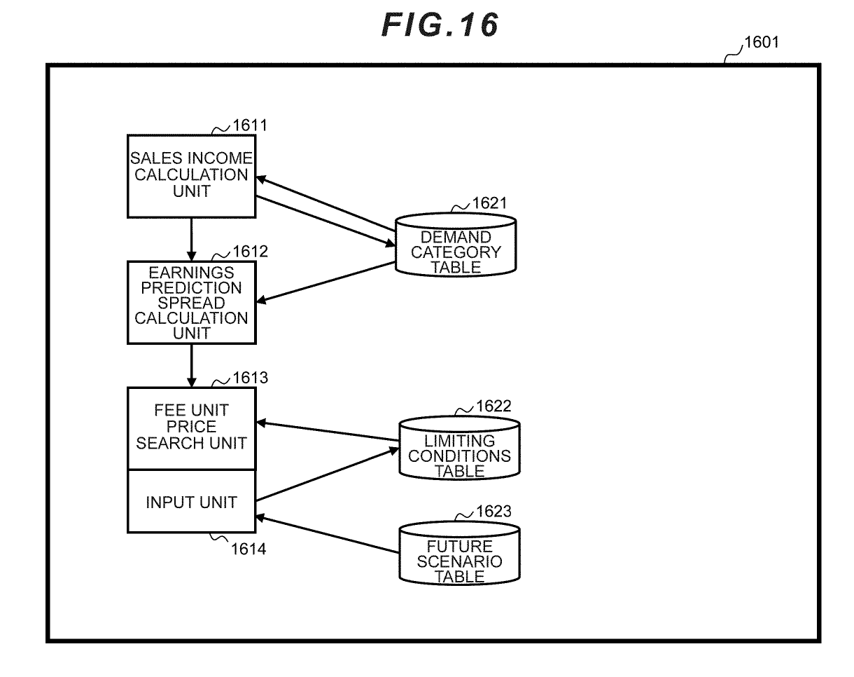

FIG. 16 is a block diagram showing a configuration of functions of a management apparatus according to a fifth embodiment of the present invention.

The management apparatus 1601 comprises a sales income calculation unit 1611, an earnings prediction spread calculation unit 1612, and a fee unit price search unit 1613.

The sales income calculation unit 1611 calculates sales income derived from supplying demand by using a time interval-differentiated fee unit price for each demand category and a power usage value. Demand categories' are units of classification for demand. Where the demand included in ‘demand categories’ is concerned, any attribute such as the contract type, industry type, demand location, and demand generation period constitute the same demand. Information for each demand category is stored in a demand category table 1621. The demand category table 1621 stores, for example, attributes common to the demand category, time interval-differentiated fee unit prices, and power usage values (time interval-differentiated usage amounts and contract maximums), for each of the demand categories. The sales income calculation unit 1611 is capable of calculating sales income for each demand category based on the demand category table 1621. The sales income calculation unit 1611 stores the sales income thus calculated for each demand category in the demand category table 1621.

The earnings prediction spread calculation unit 1612 compares power usage volumes (demand) for predetermined periods of the demand categories (for example, one day, one week, one month, three months, one year), market contract prices, and earnings for each of a plurality of future volume estimation time series relating to supply volumes (sales income and supply costs (costs required for supply)). The ‘future volume’ is the future power usage volume estimated by the future volume estimation unit 10, the contract price, and supply volume from power sources and markets. The future volume includes future values for the fee unit price when the fee unit price for each demand category is autogenerated. The estimated future volume may be at least one of the demand, contract price, and supply volume. The demand category table 1621 stores a plurality of future volume estimation time series for each demand category, for example. A plurality of future volume estimation time series for each demand category can be grasped from this table 1621. Moreover, the supply costs for each future volume estimation time series can be calculated based on the future volumes for each date and time. The ‘prediction spread’ is an index for the magnitude of dispersion of the result values obtained by performing a prediction calculation (simulation) under changed conditions. In this embodiment, the value of the difference between the maximum prediction result value and the minimum prediction result value is used.

The fee unit price search unit 1613 searches for a fee unit price which satisfies the limiting conditions for each demand category based on the result of the comparison by the earnings prediction spread calculation unit 1612. For example, the time interval-differentiated fee unit price for each demand category can be made high or low based on the margin between sales income and the costs required for supply. A limiting condition table 1622 shows the relationship between limiting conditions and fee unit prices for each limiting condition and the fee unit price search unit 1613 may also search for the fee unit price based on this table 1622.

By implementing this trading planning, configuration of a suitable fee unit price can be performed. The foregoing contributes toward the formulation of trading planning which considers earnings from individual categories and income disturbance ranges.

The fee unit price search unit 1613 preferably comprises an input unit 1614. The input unit 1614 inputs limiting conditions of either (a) upper and lower limit data for sales income amounts for each demand category or (b) upper limit data for the earnings prediction spread which is the difference in earnings calculated for each of a plurality of future scenarios (future volume time interval transitions). Although demand category contract owners can dwindle or be alienated when the fee amount payable is relatively high in comparison to others' fee amounts, fee unit prices that do not lead to reduction or alienation of contract owners can thus be configured. It is also possible to configure a fee unit price that does not induce an increase in contracts exceeding the volumes that can be supplied. In addition, (b) with limiting conditions, due to the upper limit for the earnings difference, it is possible to maintain a stable supply by obtaining a suitable fee income for which earnings fluctuations lie within a predetermined range even when any of a plurality of future scenarios arises. Note that the input unit 1614 stores limiting conditions in the limiting condition table 1622. The stored limiting conditions are associated with the demand categories (for example, the limiting condition ID is stored in the demand category table 1621). Furthermore, at least one ‘future scenario’ may also include time interval transitions for demand, market, and weather conditions in addition to future volume time interval transitions. When fee unit prices that do not alienate consumers are generated, such fee unit prices may be included in future volumes because the fee unit prices are values that will change in the future. Moreover, information representing a plurality of future scenarios is stored by a future scenario table 1623 which stores information on each future scenario.

The sales income of the demand categories preferably lies within a predetermined value range. The distribution ratio of a time interval-differentiated unit price is adjusted by the fee unit price search unit 1613, for example. By performing this trading planning, the demand category fee amount is designated at the same level as that of other electricity companies, and by changing the ratio between the daytime unit price and night unit price, earnings fluctuations for future scenario fluctuations can be minimized.

Note that the foregoing functions 1611 to 1614 and tables 1621 to 1623 are stored in the storage device 40.

### Sixth Embodiment

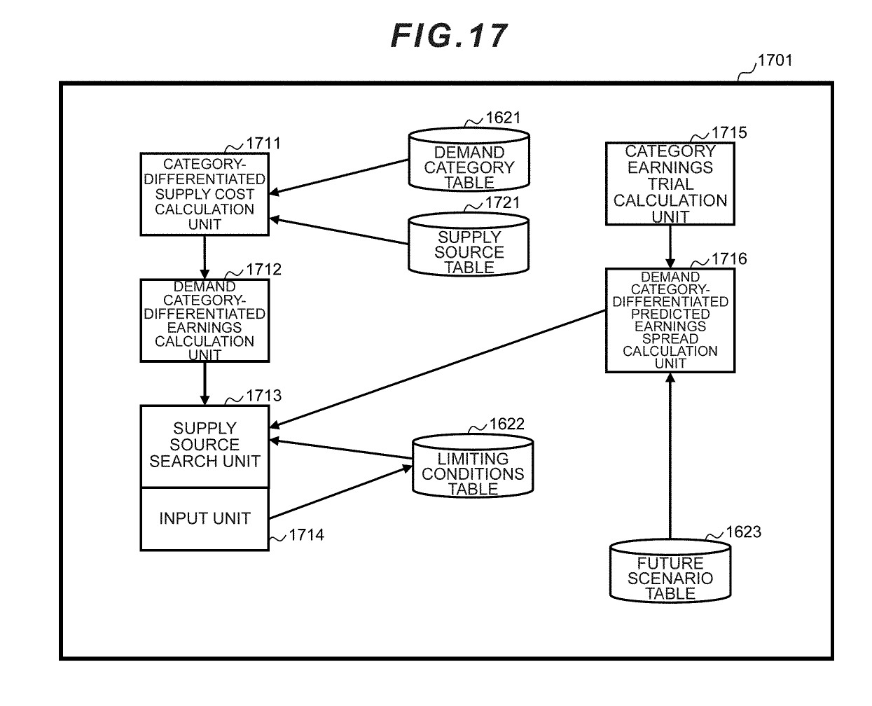

FIG. 17 is a block diagram showing a configuration of functions of a management apparatus according to a sixth embodiment of the present invention.

The management apparatus 1701 is capable of functioning as an earnings-maximizing power generation and provision adjustment apparatus. For example, the management apparatus 1701 comprises a category-differentiated supply cost calculation unit 1711, and a demand category-differentiated earnings calculation unit 1712, and a supply source search unit 1713.

The category-differentiated supply cost calculation unit 1711 calculates demand category-differentiated supply costs (calculates, for example, the product of a period unit price, which is obtained by using the supply volume to find the weighted average of the supply unit prices of each of the supply sources being used at each time, and the demand value at each time of the demand category, and totaling these products in predetermined periods). Note that the supply unit prices and supply volumes for each supply source are stored in the supply source table 1721 which stores supply source information for each supply source, for example. Further, the demand values at each time in each demand category are stored in the demand category table 1621. The category-differentiated supply cost calculation unit 1711 calculates demand category-differentiated supply costs based on these tables 1721 and 1621. In addition, a specific example of a ‘supply source’ is the aforementioned power generation business system 2000 (see FIG. 1, for example). Further, the power generation business system included in the market system A 3000 and the negawatts of the market system B 3100 are also specific examples of supply sources.

The demand category-differentiated earnings calculation unit 1712 calculates the earnings of predetermined demand categories (the difference between the supply costs and the sales income of the demand categories).

The supply source search unit 1713 searches for a combination of time interval-differentiated supply sources which satisfy limiting conditions based on the earnings (and the supply source table 1721 and limiting condition table 1622).

The supply source search unit 1713 preferably comprises an input unit 1714. The input unit 1714 inputs, for either supply costs of a predetermined demand category or for an earnings value derived from supplying the predetermined demand category, data for a limiting condition that the foregoing supply costs or earnings value be minimized or maximized. Alternatively, the input unit 1714 inputs, for either costs or earnings, upper and lower limit values as limiting conditions. By performing this trading planning, in addition to reducing the total supply costs for all demand categories, it is also possible to achieve a reduction in the supply costs for predetermined demand categories (for example, demand categories which are important as administrative issues). Note that the limiting conditions thus input are stored in the limiting condition table 1622.

The management apparatus 1701 preferably further comprises a category earnings trial calculation unit 1715 and a demand category-differentiated predicted earnings spread calculation unit 1716 in addition to the functions 1711 and 1712. The category earnings trial calculation unit 1715 performs a category earnings calculation that includes a calculation of the supply costs of a predetermined demand category (for example, by totaling the product of a period unit price and a total demand value for the demand classified by demand category, in predetermined periods), and an earnings value derived from supplying the demand category. The demand category-differentiated predicted earnings spread calculation unit 1716 compares, by demand category, earnings for each of a plurality of future scenarios (for example, time interval transitions for demand, markets, and weather). Instead of or in addition to the aforementioned search, the supply source search unit 1713 searches, by demand category, for a combination of supply sources for which the predicted earnings spread (a plurality of earnings corresponding to each of a plurality of future scenarios) is the minimum or no more than a predetermined value. Note that the ‘period unit price’ is a market contract price for delivered power or a unit price for provision from a power generation system under relative contract, or a weighted average value thereof. A ‘period’ is a delivery period (strictly speaking, may be a time frame (30 minutes, for example) of market A).

The combination of supply sources (unit commitment model) cannot be changed significantly once determined. It is therefore difficult for the supply source search unit 1713 to detect a feasible solution candidate (combination of supply sources) which satisfies the limiting condition irrespective of the future. Thus, U=[u1, u2, u3, u4, u5] and ui=[di(1), di(2), di(3), di(46), di(47), di (48)], which give combinations of supply sources required for a predetermined demand, are assumed (here, i is the unit of the supply source. di(j) is 1 when i starts in a period j and is purchased as market commodity and is 0 when stopped and not purchased as a market commodity). A set of U that can be modified from U is ϕ(U).

Furthermore, a feasible U for a future scenario D is U (D1). A ‘feasible U’ is a combination of supply sources capable of fulfilling a contract demand and supplying the market, for example.

For a plurality of future scenarios (D1, D2 and D3, for example), U*, which is included in a feasible solution product set ϕ(U(D1)) ∩ϕ (U (D1)) ∩ϕ (U (D3)) is searched as a planning value.

As one embodiment, ϕ (U (D1)), ϕ (U(D2)), and ϕ (U(D3)) could each be requested and searched for by means of a round-robbin search.

As one embodiment, a search for feasible supply sources U(D1), U(D2), and U(D3) is carried out for a plurality of supply volumes such as D1, which is a predicted value time series for the supply volume (the sum of the supply to consumers under contract, and market sales), D2, which is derived by multiplying the foregoing supply volume predicted value D1 by one or more predetermined weightings, and D3, which is derived by multiplying the foregoing supply volume predicted value D1 by no more than one weighting. Here, the search is performed with limits so that the number of starts and stops in an optional time interval segment is fixed, for example, to prevent differences in startup units between supply sources. At this time, an optimization calculation may be performed to minimize the difference in costs incurred by each of the supply sources U(D1), U(D2) and U(D3).

More specifically, by using, as minimization items in the ‘optimization calculation,’ (X1) the supply source costs incurred in supplying power (more specifically, the fuel costs consumed in supplying power or a contract price in market trading which is incurred in power provision) and (X2) a sum M (Equation 2) for the difference in power supply costs in each scenario or a variance V (Equation 3), these minimization items may be configured by taking the weighted average of (X2) and (X1) (here, N is the number of future scenarios and N=3 by way of an example).

$$\begin{matrix}M = {\sum }_{i = 1}^{N} \{ SC ( Di ) - ( SC ( Di ) + SC ( D 2 ) + ⋯ + SC ( DN ) ) \text{/} N \} & [ Equation 2 ] \\ V = {\sum }_{i = 1}^{N} \frac{{\{ SC ( Di ) - \frac{SC ( Di ) + SC ( D 2 ) + ⋯ + SC ( DN )}{N} \}}^{2}}{N} & [ Equation 3 ]\end{matrix}$$

When minimization items of this kind are used, a plan can be created without a sudden increase in the costs incurred in supply when there is a shift in the weather conditions, demand, or market contract price, and so forth. This is because (X2) acts as a penalty item in the optimization calculation and a search is made for a solution not impacting costs.

Furthermore, by using the sum or variance of (Y1) earnings from supply and sales and (Y2) the difference in earnings in each scenario as maximization items in the optimization calculation, these maximization items may be configured by taking the weighted average of (Y1) and (Y2). When such maximization items are used, a plan can be created without a sudden change in earnings when there is a shift in the weather conditions, demand or market contract price and so forth.

Furthermore, let a predetermined demand category be K, a future scenario be Di, and demand category-differentiated supply costs be SC (K, Di). The deviation or variance of SC (K, Di) and SC (K, Di) in each scenario may also be added to the minimization items. As a result, a situation where the supply costs in predetermined demand category K are large and there is a sudden change in the costs incurred in supply when there is a sudden shift in the weather conditions, demand, or market contract price, and so forth is avoided.

Furthermore, earnings P (K, Di) are taken as the demand category differentiator. The deviation or variance of P (K, Di) in each scenario may also be added. As a result, a situation is avoided where earnings from sales and supply in a predetermined demand category K change due to sudden changes in the supply costs at the time of shifts in the weather conditions, demand, or market contract prices, and so forth. P (K, Di) may also be added to the maximization items. High future supply source costs for the sales income of demand category K are avoided.

A future scenario is generated not only by multiplying D1 by a fixed value but could also be generated by multiplying by a value corresponding to the size of the prediction spread for a weather prediction at a future time. The number of future scenarios is not limited to three. For example, by using a weather numerical value prediction simulation to create a future scenario by generating a future temperature or sunlight prediction time series and also generating predicted values for demand, renewable energy power generation volume, and contract price from the future temperature or sunlight prediction time series, the weather numerical value prediction simulation can be carried out by configuring initial conditions which are obtained by adding initial perturbations to meteorological observations. When generating 20 different initial conditions which are obtained by adding initial perturbations, for example, 20 different future scenarios can be generated.

### (Explanation of Effects)

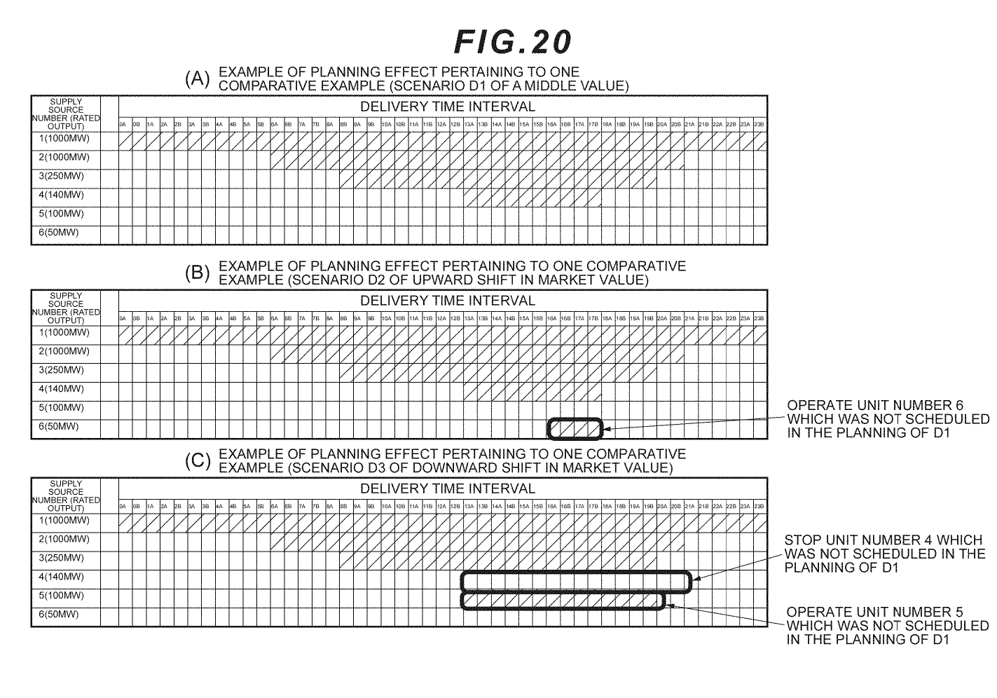

FIG. 20 (FIGS. 20A, 20B, and 20C) shows the results of combining supply sources when performing the optimization calculation (cost minimization approach) to find a combination of supply sources which minimizes supply costs for each of D1, D2 and D3 without using the supply source search apparatus (an example of the management apparatus) of this embodiment.

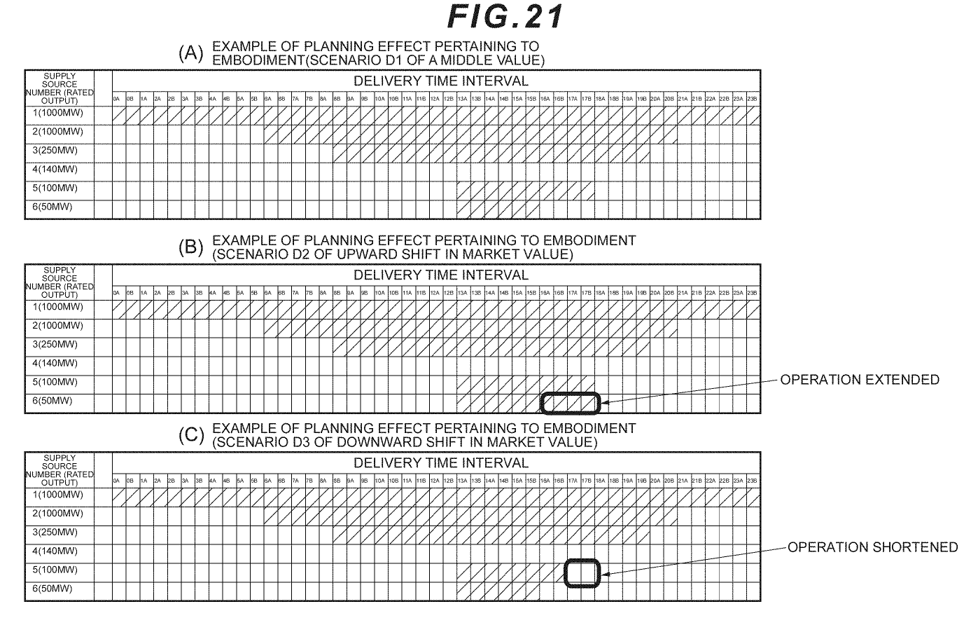

FIG. 21 (FIGS. 21A, 21B and 21C) show search results using the supply source search apparatus of this embodiment.

The horizontal axis in FIG. 21 represents the delivery time and a time interval from 10:00 until 10:30 is shown as ‘10A’ and a time interval from 10:30 until 11:00 is shown as ‘10B.’ The vertical axis represents unit numbers specifying supply sources. Densely shaded areas on the charts indicate supply sources in operation or purchases being made as market commodities.

Furthermore, a future scenario D1 for power delivery at each of the times is a future scenario which uses middle values for predictions of demand and market contract prices. A future scenario D2 is a future scenario with increased sales volume (demand) as a result of the market contract price rising above the case of D1 or of increasing sales to market, and so on. A future scenario D3 is a future scenario with reduced sales volume (demand) as a result of the market contract price falling below the case of D1 or of reducing sales to market, and so on.

In planning using a cost minimization method for supply costs which does not use the method according to this embodiment, the plan dictates that, in future scenario D1, units 5 and 6 will not operate and unit 4 will operate (FIG. 20A). In the plan for future scenario D2, although unit 6 is not scheduled to operate in the case of future scenario D1, unit 6 is operating due to an increase in demand, above that of D1, from 16:00 until 18:00 (FIG. 20B). In the plan for future scenario D3, because the demand from 17:00 until 18:00 is less than for D1, unit 5 is being operated instead of unit 4 even though, to begin with, unit 4 operates at a larger rated capacity than unit 5 (FIG. 20C).

Thus, in planning using a cost minimization approach, although costs are minimized in each of future scenarios D1, D2 and D3, the power generators and supply sources which are operated change whenever a future scenario changes (the output of the future volume estimation unit changes as a result of the weather report being updated), and it is not possible to operate an actual power generation system, which needs preparations such as those for the arrangement of operators as early as the previous day, under any future scenario.

However, with the method according to this embodiment, unit 4 is not operated in any of future scenarios D1 to D3, as shown in FIGS. 20A, 20B and 20C. If there is an increase in demand from 16:00 until 18:00, the demand can be matched due to the effect of unit 6 operating (FIG. 20B). It can also be seen that if there is a reduction in demand from 17:00 until 18:00, the demand can be matched by shortening the operating time of unit 5 (FIG. 20C).

It can be seen that operation following the plan can be implemented by shortening or extending the operating times of supply sources which are capable of handling specific preparations for any future scenario and without changing preparations for power generation system operators put in place as early as the previous day or changing fuel arrangements.

The search processing for a fee unit price search or a search for a supply source combination according to this embodiment is implemented by means of an interior point method which searches for a solution which has looked at limiting conditions, Karmarkar's method, a branch and bound method, or constrained programming. A search may also be made using a round-robbin search for solution candidate table data that is optionally designated by the user. The present invention is not limited to or by the foregoing search methods, rather, searches involving heuristic methods such as generic algorithms or reinforcement learning may also be performed.

Note that the foregoing functions 1711 to 1716 and table 1721 are stored in the storage device 40.

### Seventh Embodiment

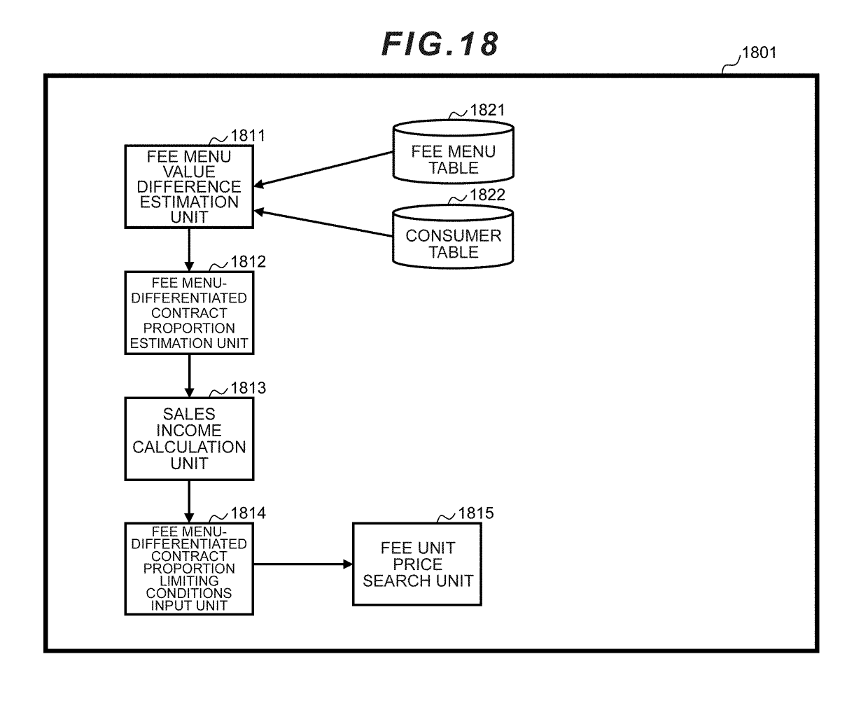

FIG. 18 is a block diagram showing a configuration of functions of the management apparatus according to a seventh embodiment of the present invention.

The management apparatus 1801 is capable of functioning as a contract switch rate estimation apparatus. For example, the management apparatus 1801 comprises a fee menu value difference estimation unit 1811, a fee menu-differentiated contract proportion estimation unit 1812, a sales income calculation unit 1813, a fee menu-differentiated contract proportion limiting condition input unit 1814 and a fee unit price search unit 1815.

The fee menu value difference estimation unit 1811 estimates, for power fees payable by consumers, the difference between the payment amount in the change candidate fee menu (provisional post-change payment amount) and the payment amount in the fee menu before the change (pre-change payment amount). This estimation may be performed differentiated by demand category or may be performed differentiated by consumer. Furthermore, this estimation may be executed based on a fee menu table 1821. The fee menu table 1821 stores information relating to a plurality of fee menus. The table 1821 may store pre- and post-change fee menu information for each fee menu. In addition, it is possible to specify which consumer corresponds to which fee menu based on a consumer table 1822 which stores information on each consumer.

The fee menu-differentiated contract proportion estimation unit 1812 estimates the selection proportion for each fee menu in a future planning period based on the fee menu value difference estimation amount (estimated difference). The fee menu-differentiated contract proportion estimation unit 1812 is capable of calculating the switch rate (contract change rate) between the logistic regression curve and the next planning period and estimating the selection proportion for each fee menu in a future planning period based on the calculated switch rate, for example. For example, the estimation unit 1812 is capable of making an estimation of the percentage x of consumers, which is a set obtained through classification by demand category, who change their contract to another fee menu when there is a difference in the payment amount of y yen per month (‘consumer alienation’ when there has been a change to a fee menu presented by another company), and so on. Note that although this percentage is treated as a definite ‘proportion’ here, same could also be treated stochastically as a ‘probability’ of change for individuals.

The sales income calculation unit 1813 calculates sales income for each demand category based on the payment amount. More specifically, the sales income calculation unit 1813 calculates sales income for each pre-change payment amount and post-change payment amount. Still more specifically, for example, after fee unit price change guidance has been created by processing, described subsequently, by the fee unit price search unit 1815, the sales income calculation unit 1813 normally executes processing to calculate each sales income (and, for example, visualization processing to enable the sales incomes to be compared).

The fee menu-differentiated contract proportion limiting condition input unit 1814 designates the increase/reduction rate of the fee menu-differentiated contract proportion (an example of a fee menu-differentiated contract proportion limiting condition) for the demand category.

The fee unit price search unit 1815 determines the fee unit price at which the contract proportion or number of contracts is of a predetermined value, based on the designated increase/reduction rate. Note that the fee unit price is determined from the logistic regression curve, for example. For example, the increase/reduction rate is assumed to correspond to the logistic regression curve of (Equation 4). The increase/reduction rate Y is calculated by using a price difference (fee menu value difference estimation amount) X and coefficients a, b and c. The coefficients a, b and c may be determined by means of logistic regression estimation processing from previous data.

$$Y = \frac{a}{1 + b \times {e}^{cX}} \qquad [ Equation 4 ]$$

Note that the foregoing functions 1811 to 1815 and tables 1821 to 1822 are stored in the storage device 40.

### Eighth Embodiment

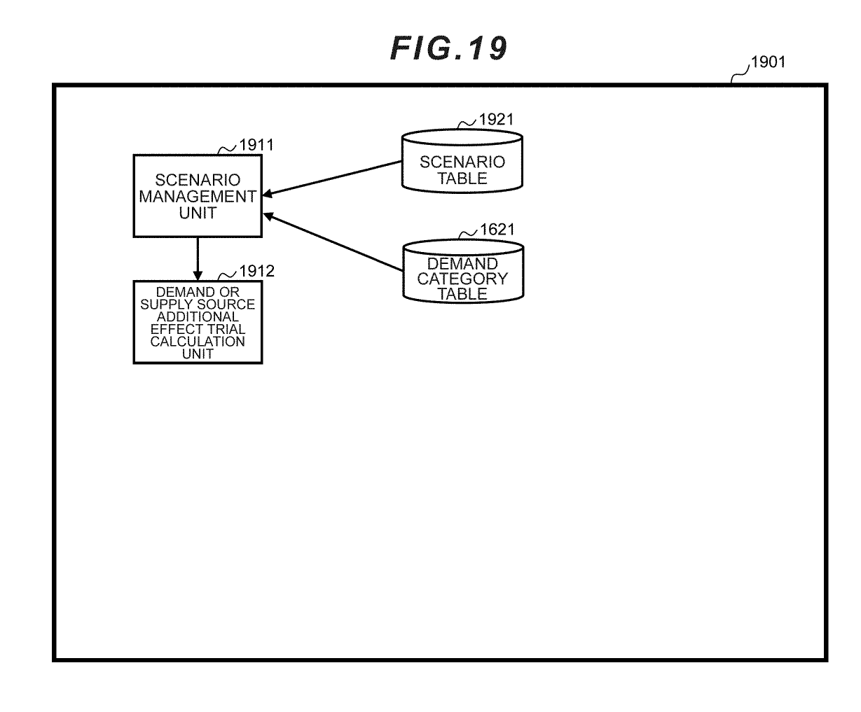

FIG. 19 is a block diagram showing a configuration of functions of a management apparatus according to an eighth embodiment of the present invention.

A management apparatus 1901 is capable of functioning as a buying value evaluation apparatus. For example, the management apparatus 1901 comprises a scenario management unit 1911 and a demand or supply source additional effect trial calculation unit 1912. Note that the ‘buying’ target may be at least one of the following.
Sales rights to meet demand;
Rights to receive supply from a power generation system (purchase rights) or rights to a power generation system; and
   Purchase rights and sales rights for commodities on another market B (power distribution rights, fuel and negawatts usage rights).
   The purchase target may be a company (a new electric power company, for example), and the acquisition of sales rights and purchase rights is possible through the purchase of a company. A ‘scenario’ may also be the same as a future scenario. However, the generation of future scenario candidates according to this embodiment differs from the foregoing embodiments. More specifically, increased demand due to purchasing and increased supply source volume due to purchasing are added (in the foregoing embodiments, scenarios involved uncontrollable phenomena such as increased demand after temperatures have risen, whereas the scenarios of this embodiment involve controlled (purchase) scenarios).

The scenario management unit 1911 calculates an earnings prediction spread which uses a first scenario (designated scenario), and an earnings prediction spread which uses a second scenario (a scenario obtained by adding the value of the demand of a predetermined demand category or the value of the supply of a predetermined supply category to the demand and supply values of the first scenario, or by changing these demand and supply values). Note that scenario-related information (for example, scenario demand and supply values) is stored in a scenario table 1921 which stores information on each scenario, for example. The demand values or supply values of predetermined demand categories are stored in the demand category table 1621, for example. The scenario management unit 1911 is capable of calculating an earnings prediction spread which uses a first scenario and an earnings prediction spread which uses a second scenario based on the tables 1921 and 1621. Furthermore, a ‘supply category’ is a unit of classification of supply sources (a unit of classification by means of attribute classification). With regard to supply sources which are included in the same ‘supply categories,’ any attribute such as the power generation fuel type, capacity, power generation time zone, site location, and commodity type when making a wholesale power trade constitute the same supply source.

The demand or supply source additional effect trial calculation unit 1912 compares and displays the earnings prediction spread which uses the first scenario and the earnings prediction spread which uses the second scenario.

Note that the foregoing functions 1911 to 1912 and table 1921 are stored in the storage device 40.

### Ninth Embodiment

The ninth embodiment is equivalent to a synthesis of the fifth to eighth embodiments (may also include at least one of the first to fourth embodiments). This synthesis may also include items not appearing in the foregoing explanations.

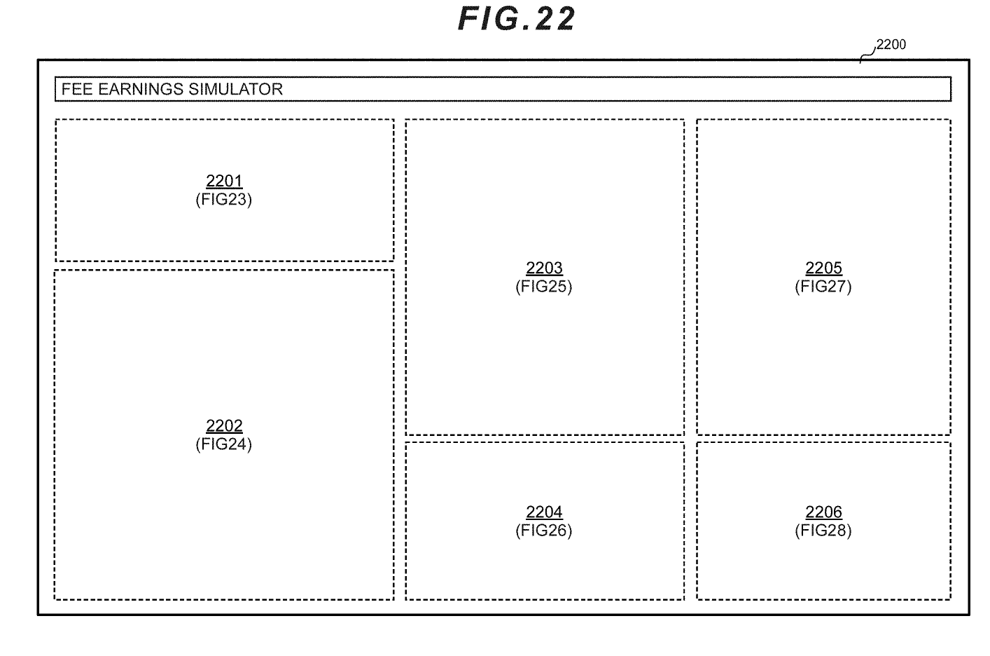

The processor unit of the management apparatus displays screens (for example, GUIs (Graphical User Interfaces)) which are illustrated in FIGS. 22, 29, 33, 37, 43, 47 and 53. More specifically, for example, the processor unit of the management apparatus performs or supports steps such as:

STEP1: consumer grouping and earnings structure visualization;
STEP2: determination of fee agreements;
STEP3: determination of power supply configuration; and
STEP4: creation of weekly plan (the period is not necessarily a week).
The information which is displayed on these screens is displayed based on at least a portion of the information managed by the management apparatus. In other words, the information which is displayed on these screens is stored, for example, in a storage unit (a memory unit, for instance) in the management apparatus and information is displayed on the screens described below based on this information.

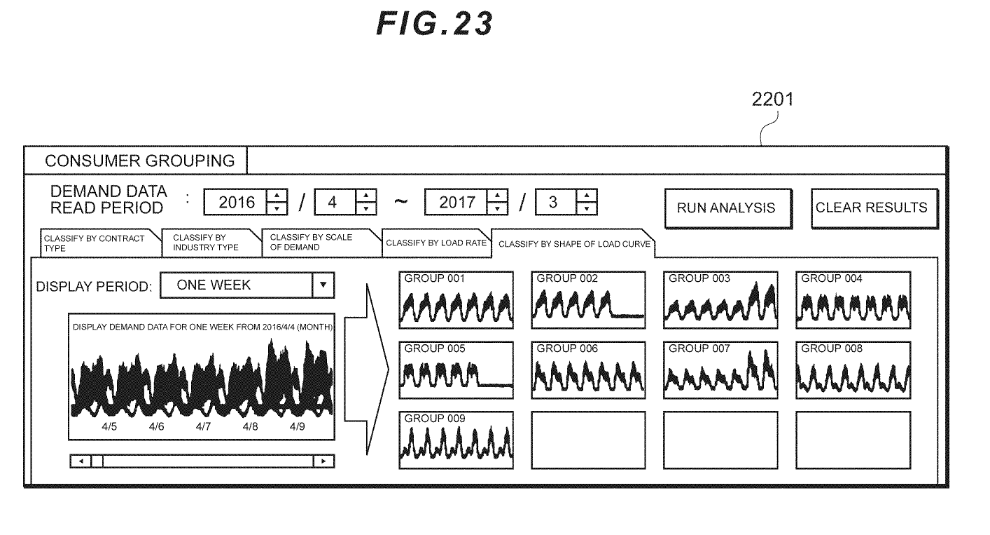

The processor unit of the management apparatus displays a screen 2200 which is illustrated in FIG. 22 for STEP1. More specifically, FIG. 22 shows the overall configuration of a fee earnings simulator screen 2200. The information parts 2201 to 2206 which are shown in FIGS. 23 to 28 are each displayed on the screen 2200. The specific details are as follows.

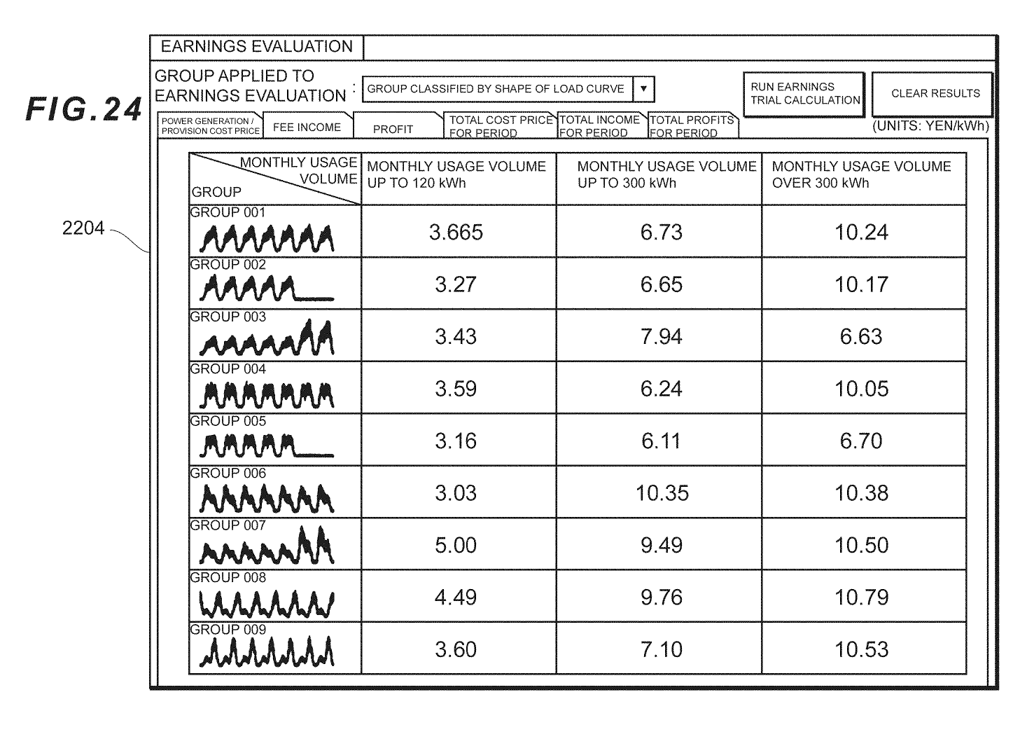

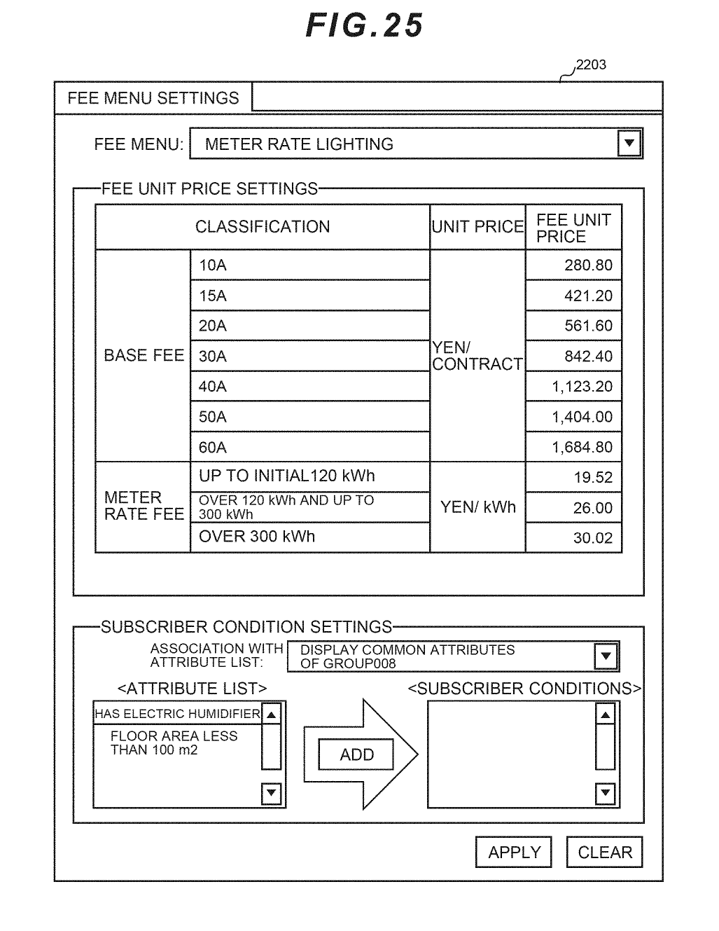

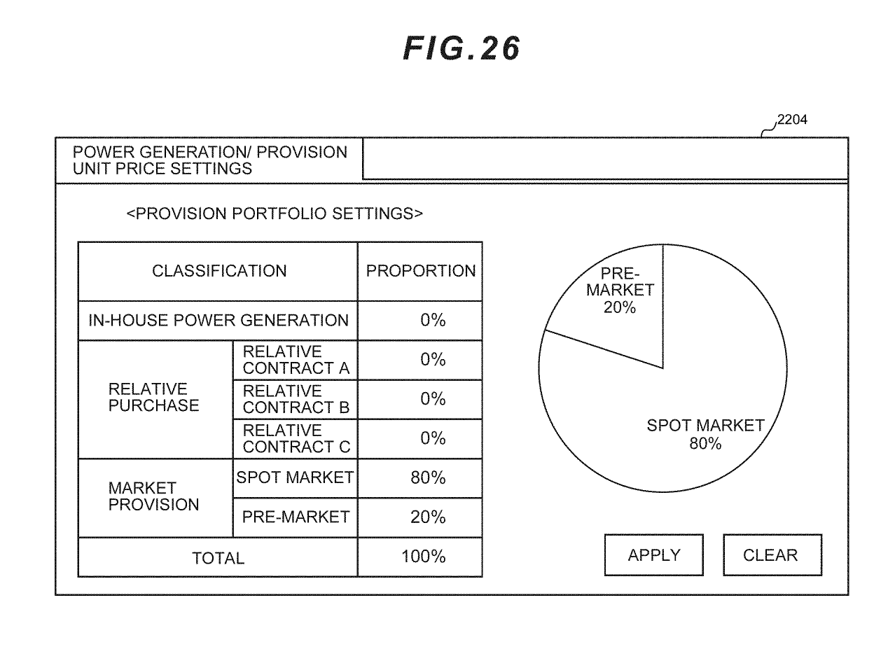

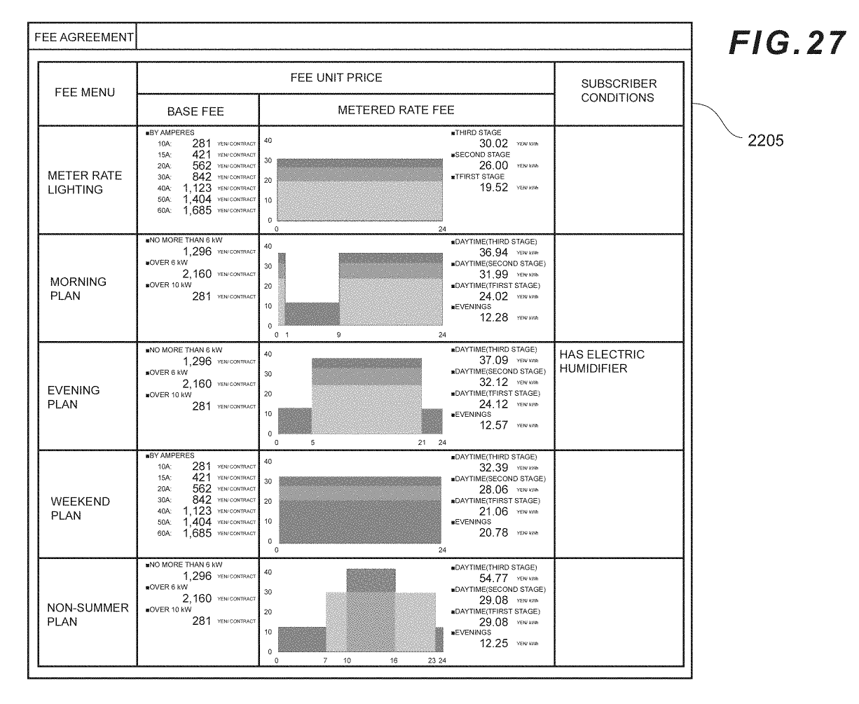

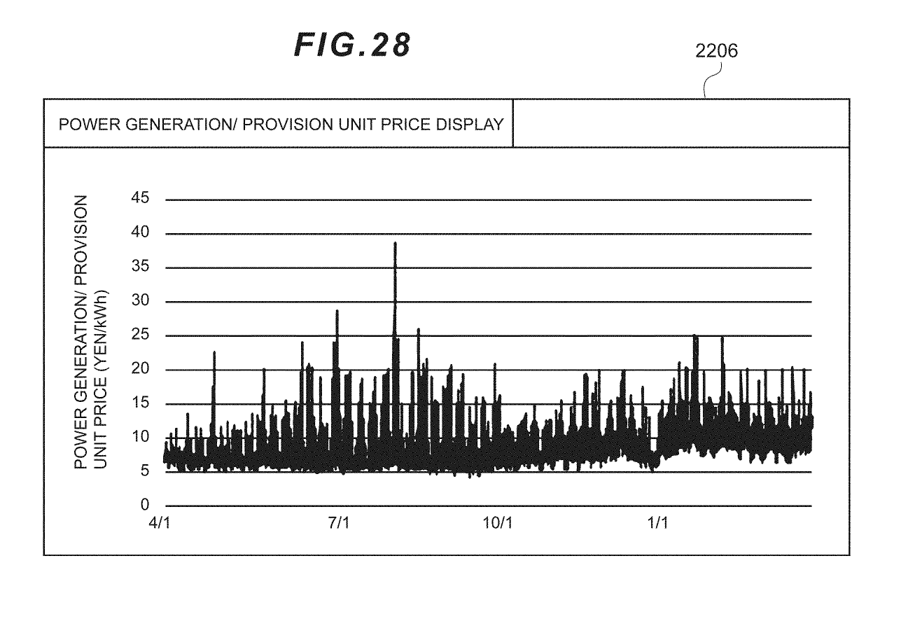

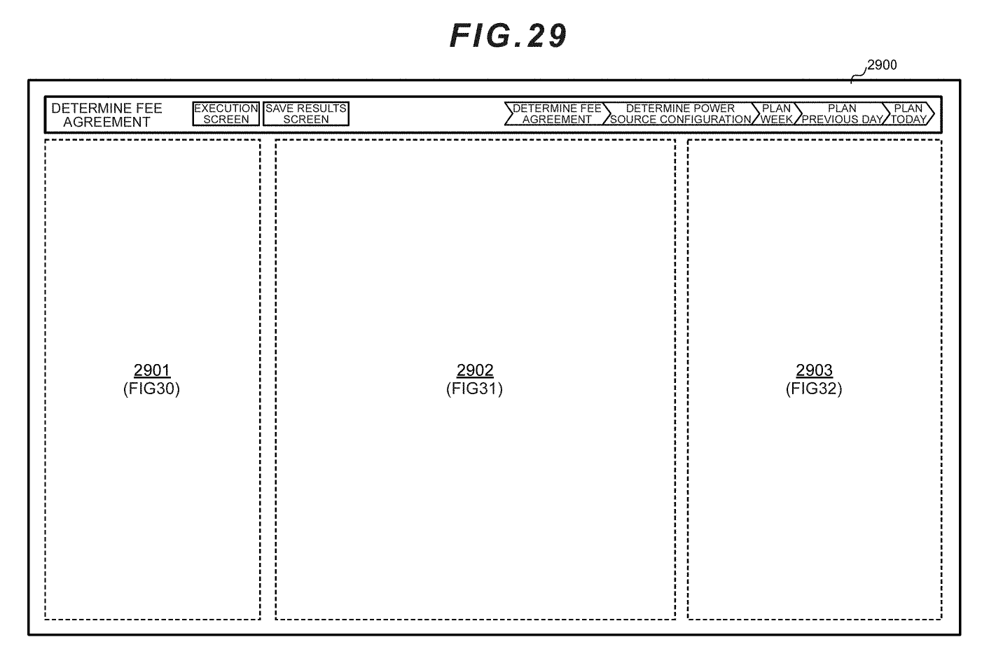

(FIG. 23: information part 2201) The results of processing to classify the collected demand time series data by demand category are output (the ‘consumer grouping’ display portion in the top left).
(FIG. 24: information part 2202) The results of calculating earnings, supply costs and sales income for each demand category are output (the ‘earnings evaluation’ display portion in the bottom left).
(FIG. 25: information part 2203) The values for fee unit prices pertaining to the sales income are input and the fee unit prices thus input are displayed. The fee unit prices are saved by designating fee menu names (center top of the screen). Conditions for consumers eligible to subscribe and designations for the attributes of permitted demand categories, and the like, are added and saved in the fee menu. (Center of screen) Fee menu configurations are input and displayed here. (Center top half of screen).
(FIG. 26: information part 2204) Trial calculation conditions relating to supply costs are configured. (Center bottom half of screen, ‘power generation/provision cost price settings’ input/output unit). Here, inputs of default values for the proportion of in-house generator power generation, the proportion of power generation from power generation systems under relative contract, and the proportion of market provision from each market (the proportion from the spot market and proportion from the pre-market) for supplied power are accepted and the input results are displayed. Assumed values for each of the power generation cost prices and market contract prices are saved in a database (not shown).
(FIG. 27: information part 2205) The fee menu in (3) above displays fee menu names and fee unit prices (basic fee and metered rate fee) as subscription conditions (the ‘fee menu display’ display portion in the top right of the screen). Among the fee unit prices, unit prices which are different for each time interval (time zone-differentiated unit prices for the metered rate fee) are displayed as a graph in which time zones are plotted on the horizontal axis and unit price values are plotted on the vertical axis.
(FIG. 28: information part 2206) Time series values for a predetermined period (one year, for example) are displayed for trial calculation conditions relating to supply costs (the ‘power generation/provision cost price display’ display portion in the bottom right of the screen).

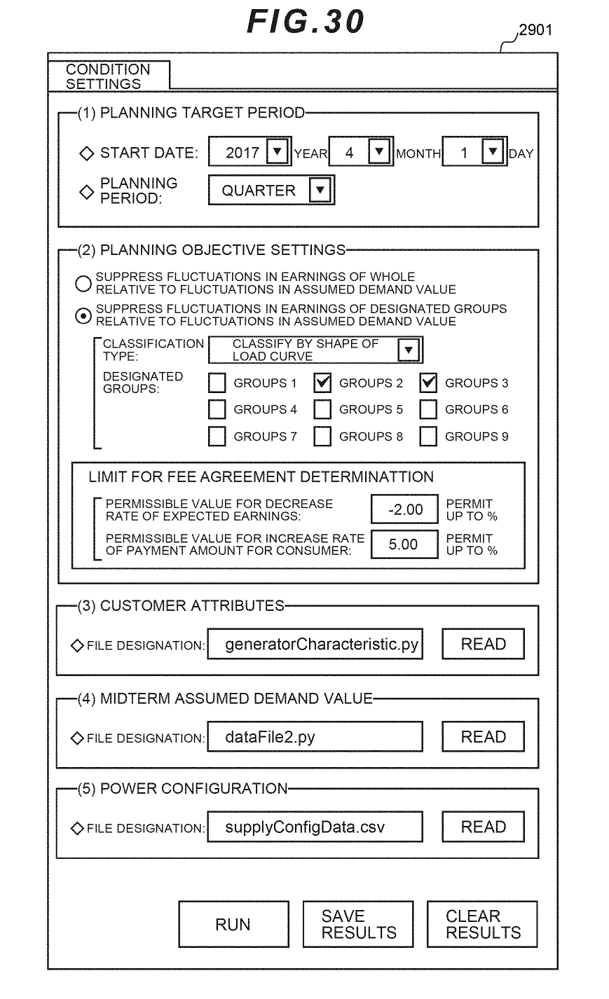

The processor unit of the management apparatus displays a screen 2900 which relates to execution and is illustrated in FIG. 29 for STEP2. More specifically, FIG. 29 shows the overall configuration of the fee agreement determination screen 2900. Information parts 2901 to 2903 shown in FIGS. 30 to 32 are each displayed on the screen 2900. The specific details are as follows.

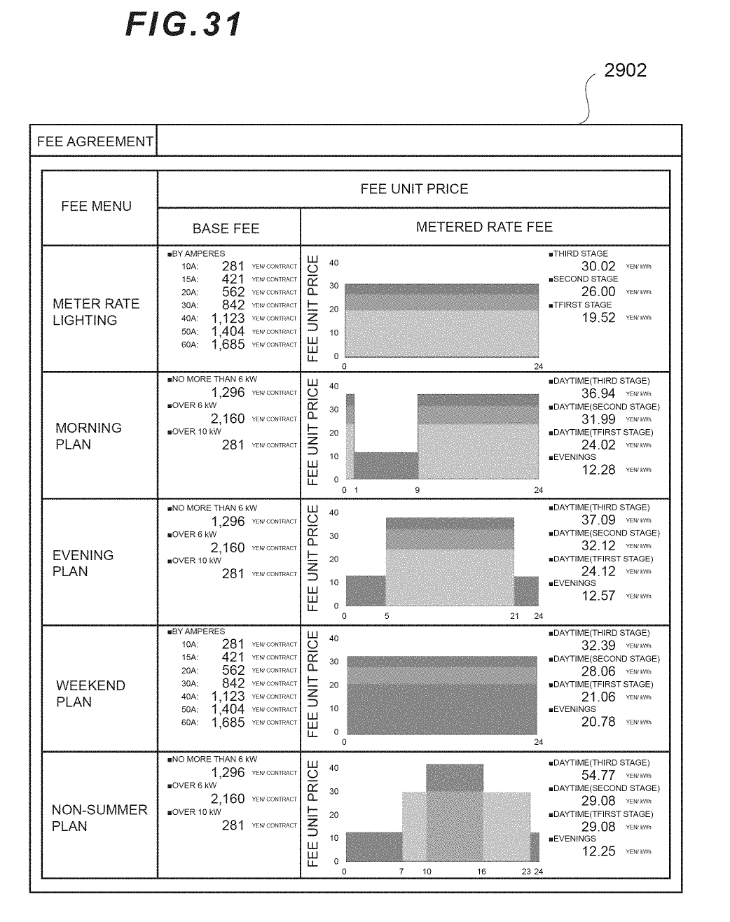

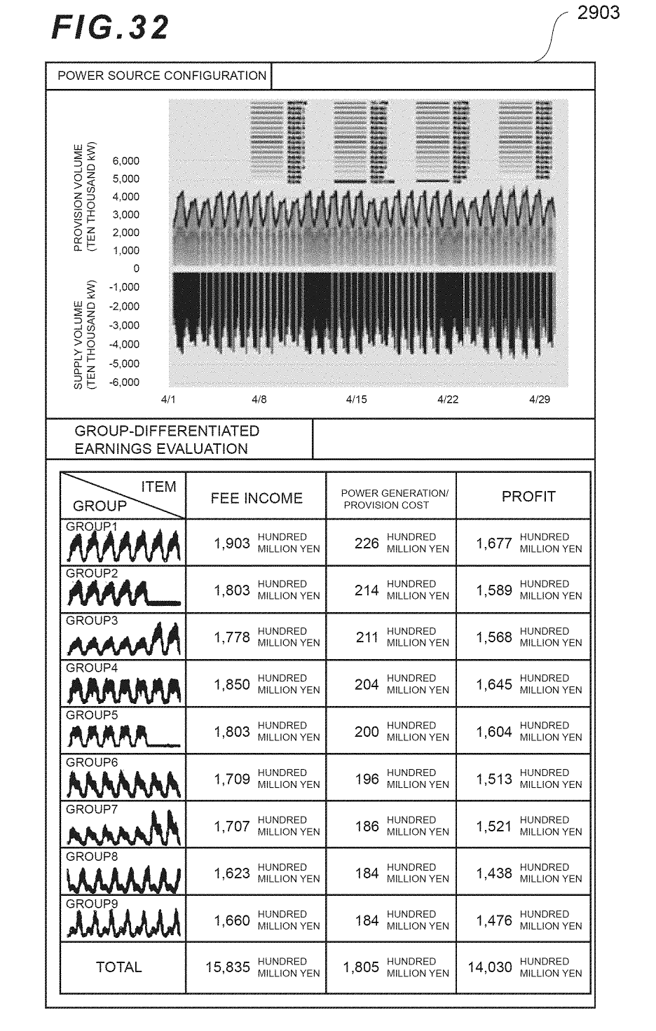

(FIG. 30: information part 2901) For fee unit prices, in exchange for values input by the user, a search for a fee unit price satisfying the designated condition is performed (the search is conducted by pressing the run (execution) button in FIG. 30). The fee unit price search conditions are designated by reading a future scenario (assumed demand value and fluctuations in the assumed demand value), fee menu values (customer attributes) in the contract of each consumer, and power supply (provision) time interval-differentiated proportions from a database (not shown). Moreover, in the fee unit price search, options to minimize earnings and costs relating to specific demand categories (displayed as ‘demand groups’ in the screen example) and to minimize fluctuations in earnings and costs can be designated. (The above refers to the ‘condition settings’ input/output portion on the left of the screen in FIG. 29).
(FIG. 32: top of information part 2903) Assumed values for power provision and assumed sales values are read from a database and displayed in a bar graph in which time is plotted on the horizontal axis (displayed in periods of a quarter or one year), the provision volume is plotted on the upper half of the vertical axis (proportions of provisioned power from supply sources and markets are displayed in a bar graph for each delivery time interval) and the corresponding supply volume in each delivery time interval is plotted on the lower half of the vertical axis (company's own sales to consumers and sales volumes to the market) (the ‘power source configuration’ display portion in the top right of FIG. 29).
(FIG. 31: information part 2901 and FIG. 32: bottom of information part 2903) The fee unit price which has been searched for and which satisfies the search conditions is displayed in the ‘fee agreement’ display portion (center of the screen in FIG. 29). The earnings, sales income and supply costs for this searched for fee unit price are displayed differentiated by demand category. (The ‘group-differentiated earnings evaluation’ display portion in the bottom right of FIG. 29).

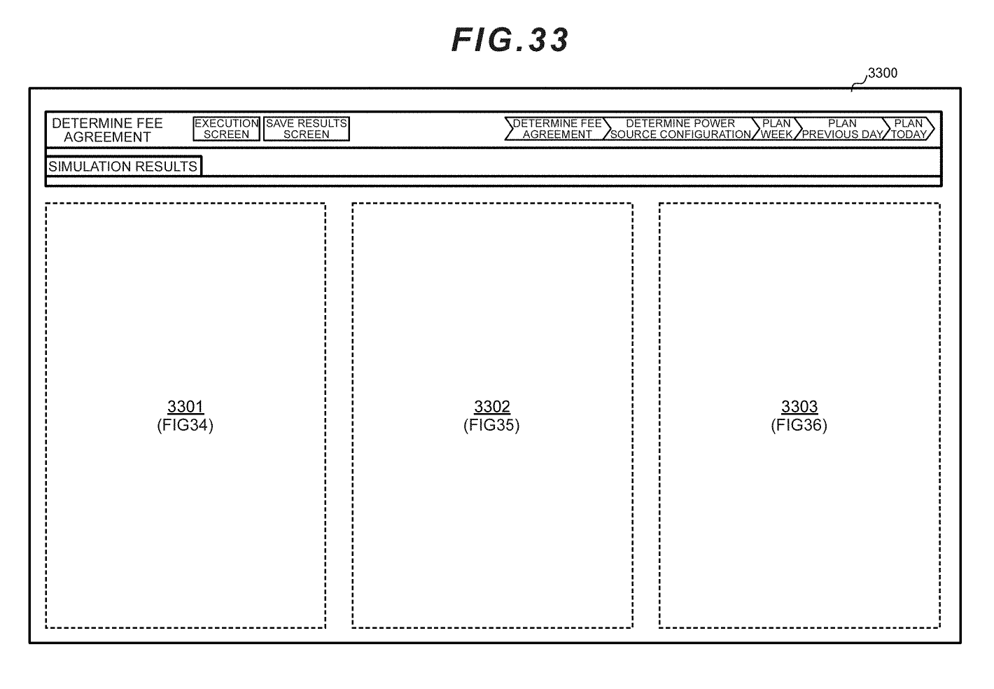

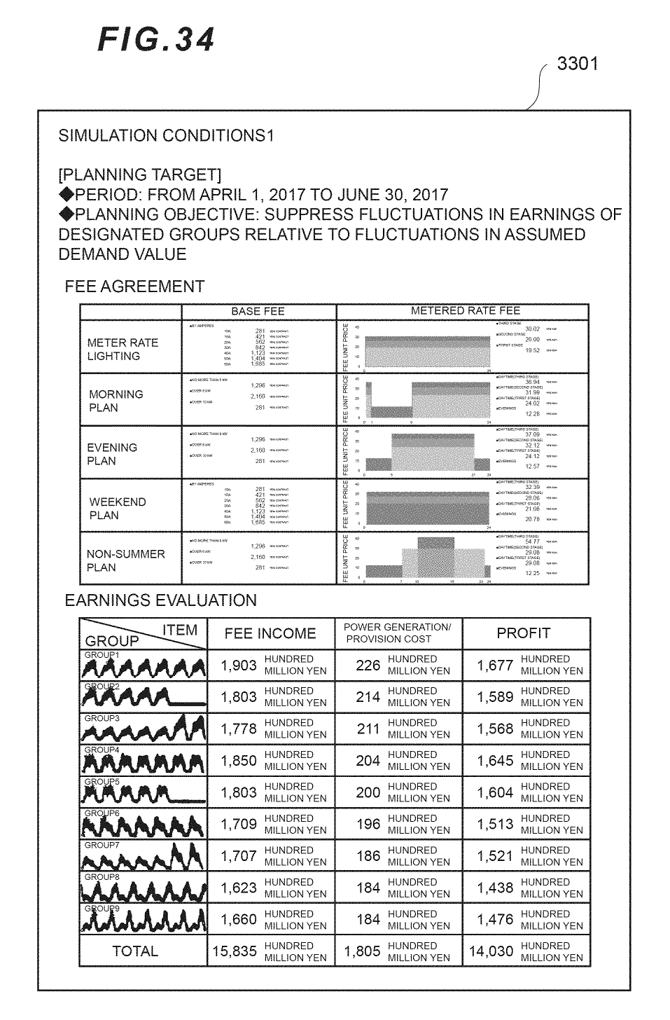

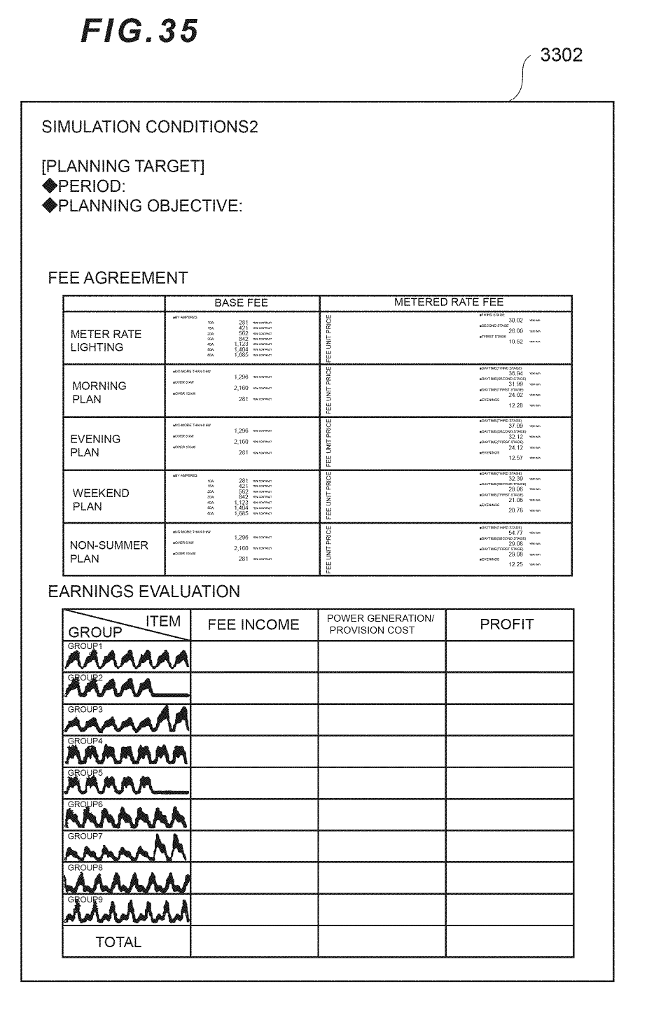

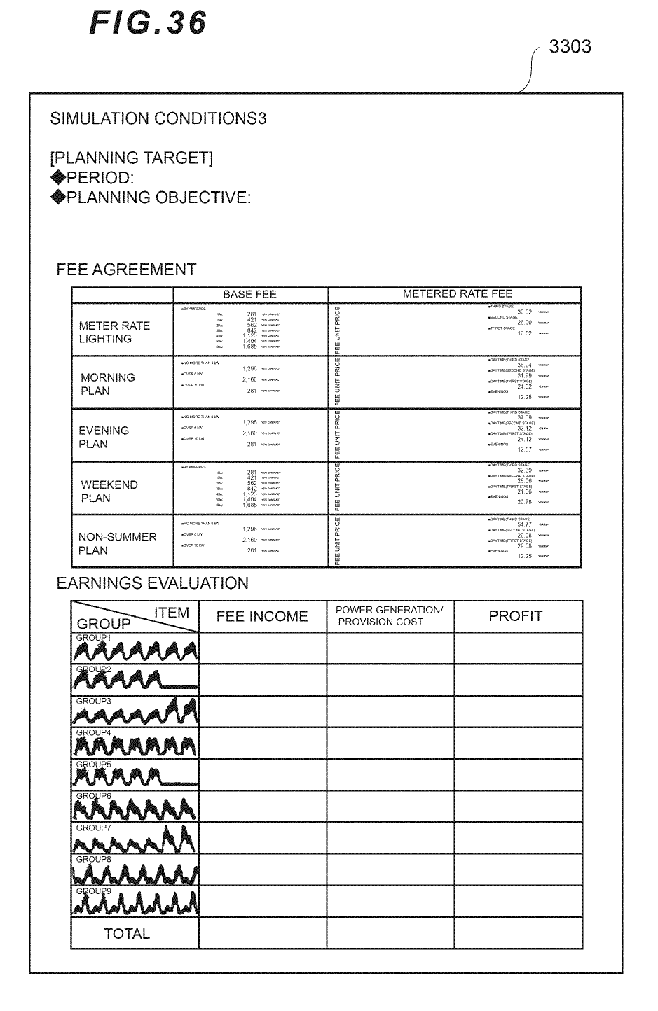

The search results are saved after designating the search conditions and executing the search, by pressing the save results button in FIG. 30. The saved results are each posted on the ‘simulation results’ screen 3300 (FIG. 33). The screen 3300 shown in FIG. 33 displays information parts 3301 to 3303 (FIGS. 34 to 36) which show simulation results 1 to 3, for example.

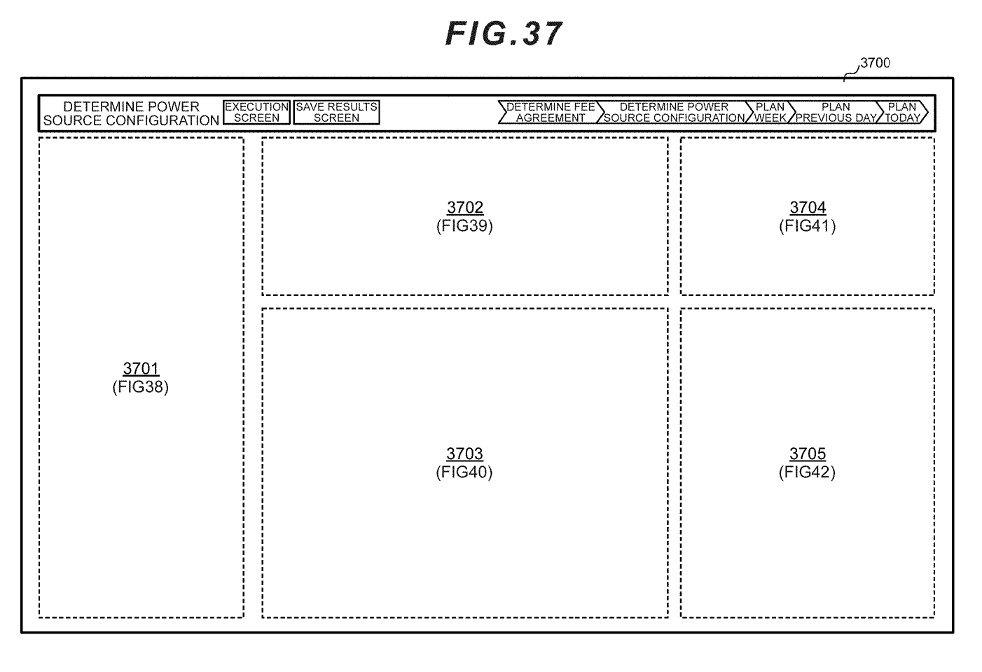

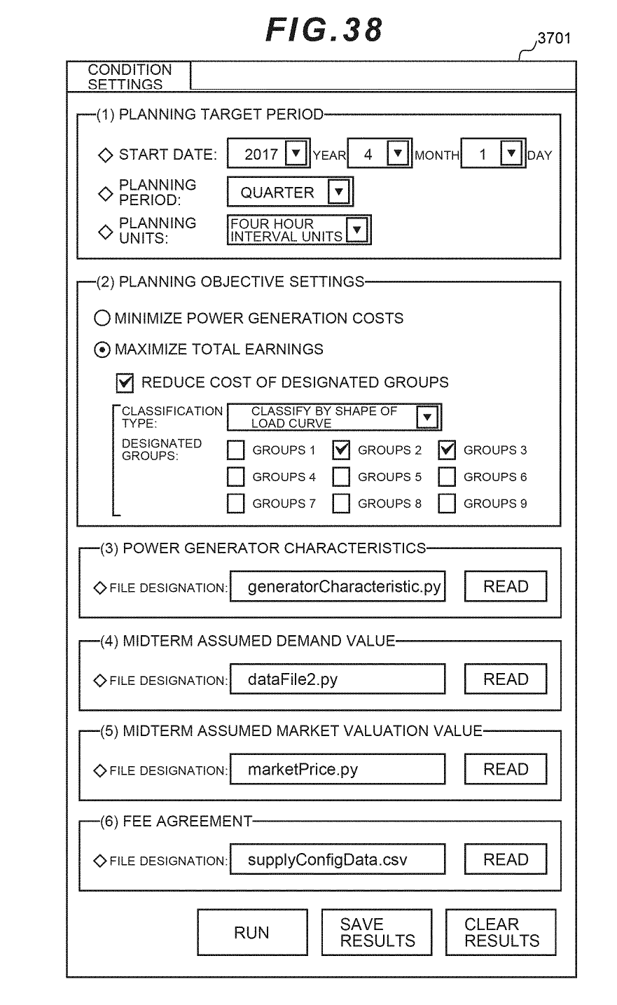

The processor unit of the management apparatus displays a screen 3700 which relates to execution and is illustrated in FIG. 37 for STEP3. More specifically, FIG. 37 shows the overall configuration of the power source configuration determination screen 3700. Information parts 3701 to 3705 shown in FIGS. 38 to 42 are each displayed on the screen 3700. The specific details are as follows.

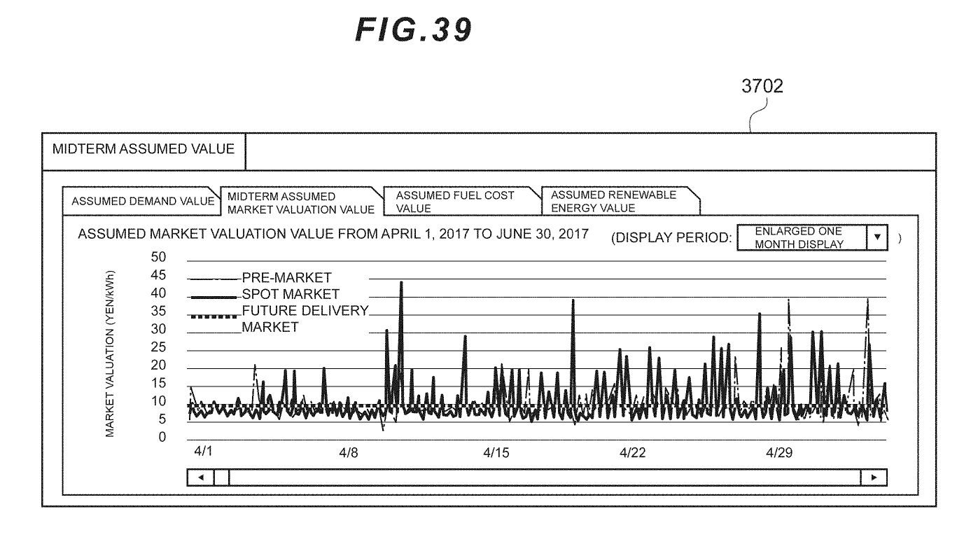

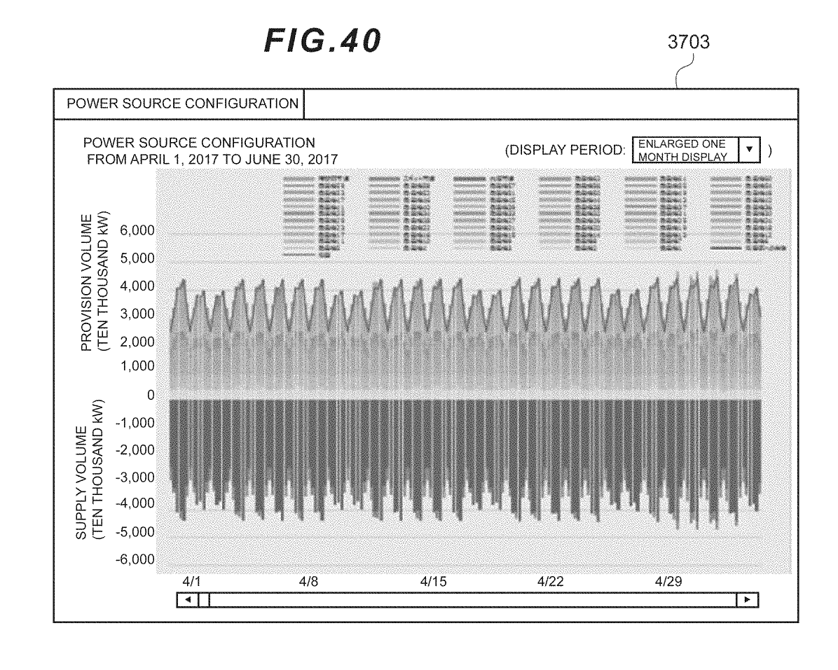

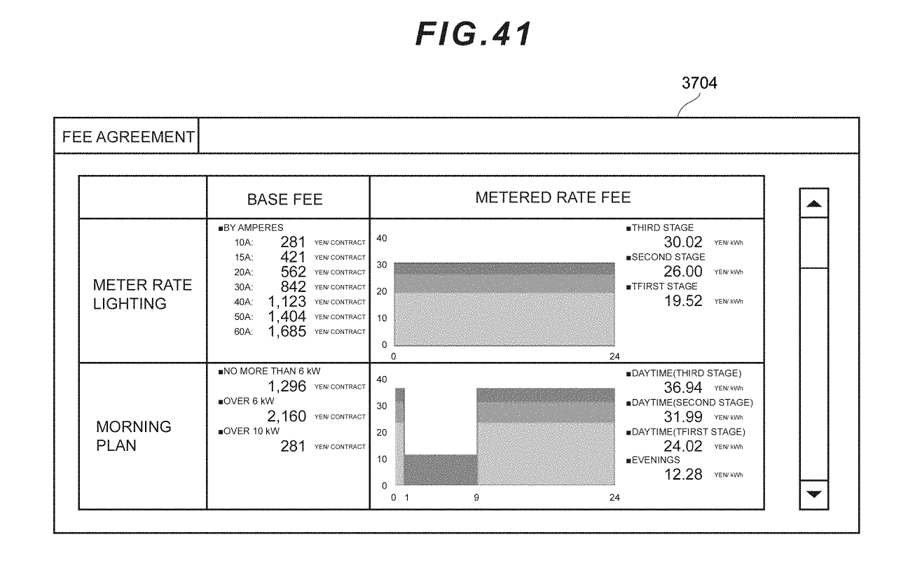

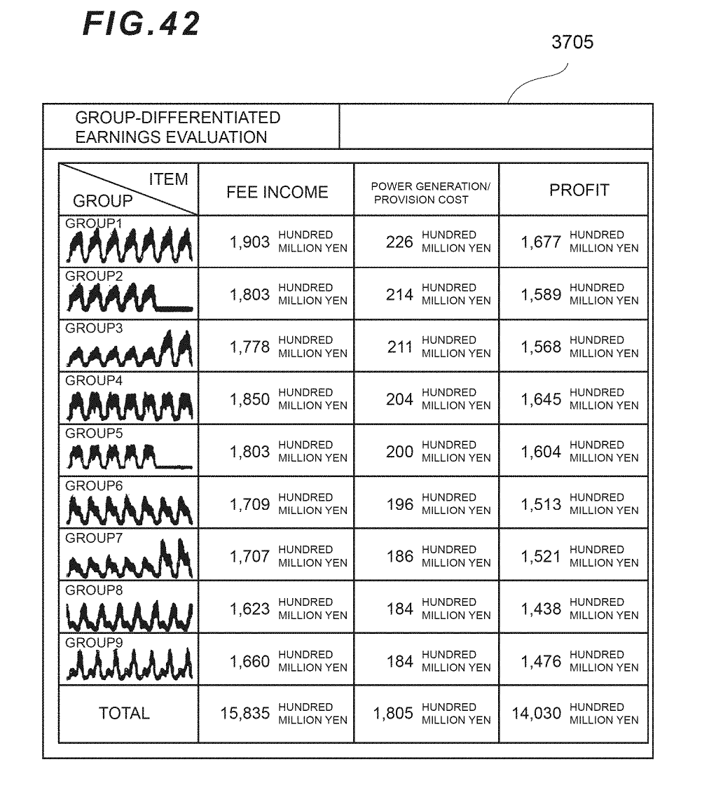

(FIG. 38: information part 3701) Conditions for searching for a power source configuration (proportions pertaining to supply sources for power generation and market provision in each delivery time interval, which are a condition of power generation/provision cost price settings) are input. As the search conditions, designations can be made regarding whether to minimize total power generation costs or maximize earnings derived from sales and supply. Furthermore, a designation can be made to reduce the cost of a specific demand category (a check box to make a designation to suppress cost fluctuations may also be provided as another embodiment). Moreover, as the search conditions, the generator cost characteristics (fuel costs for each time interval), assumed demand value, assumed market price value, and fee agreement (fee unit price) (information part 3704 in FIG. 41 is used, for example) are designated and read from a database (the ‘condition settings’ input/output portion on the cleft side of FIG. 37).
(FIG. 39: information part 3702) Numerical values relating to the search conditions thus read (demand, market price, and fuel costs) and past and future renewable energy volumes which are stored in the database are displayed (Midterm assumed values' in the center top of FIG. 37).
(FIG. 40 information part 3703) By pressing the ‘run’ button in FIG. 38, the power source configuration of the searched result and the supply thereof (sale) are displayed in a bar graph in which time is plotted on the horizontal axis (displayed in periods of a quarter or one year), the provision volume is plotted on the upper half of the vertical axis (proportions of provisioned power from supply sources and markets are displayed in a bar graph for each delivery time interval) and the corresponding supply volume in each delivery time interval is plotted on the lower half of the vertical axis (company's own sales to consumers and sales volumes to the market) (the ‘power source configuration’ display portion in the lower center section of FIG. 37).
(FIG. 42: information part 3705) The demand category-differentiated sales income (‘fee income’), costs (‘power generation provision costs’), and earnings (‘profits’) are output for each search result. (The ‘group-differentiated earnings evaluation’ display portion in the bottom right of FIG. 37).

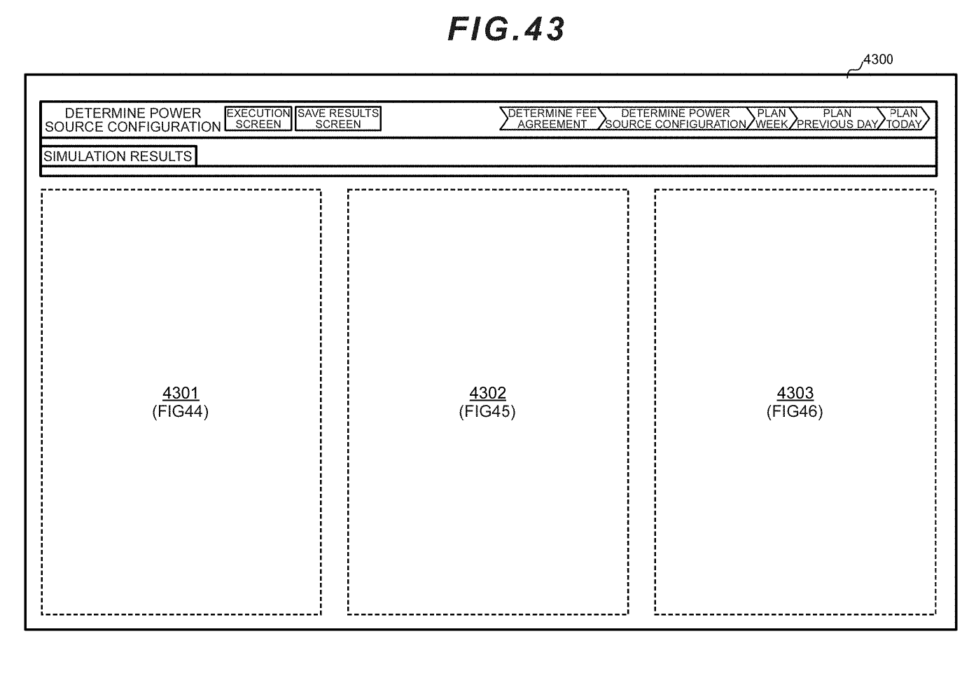

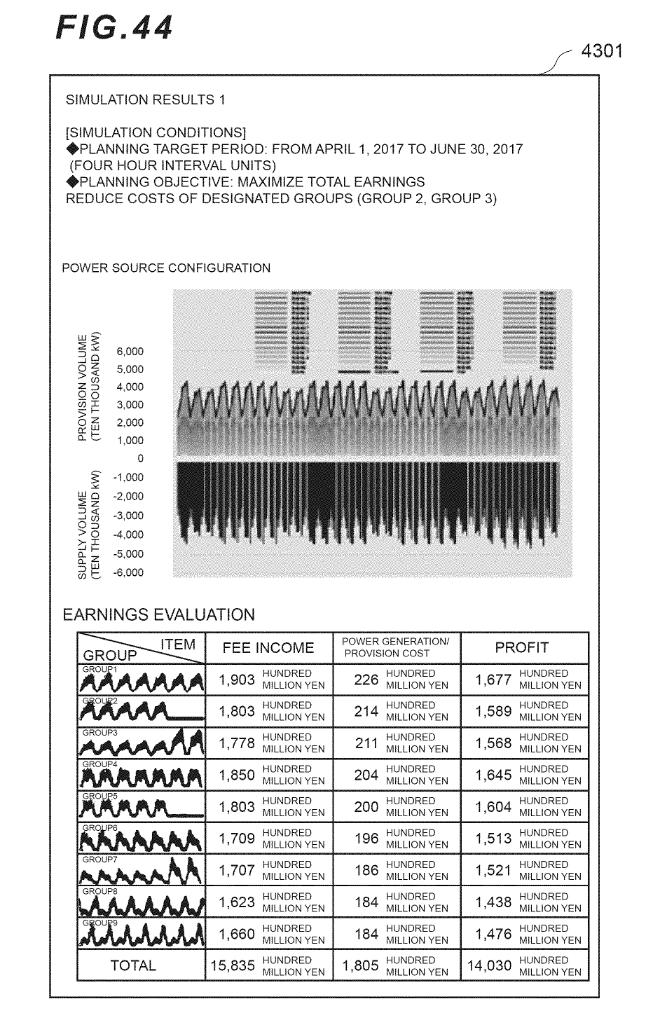

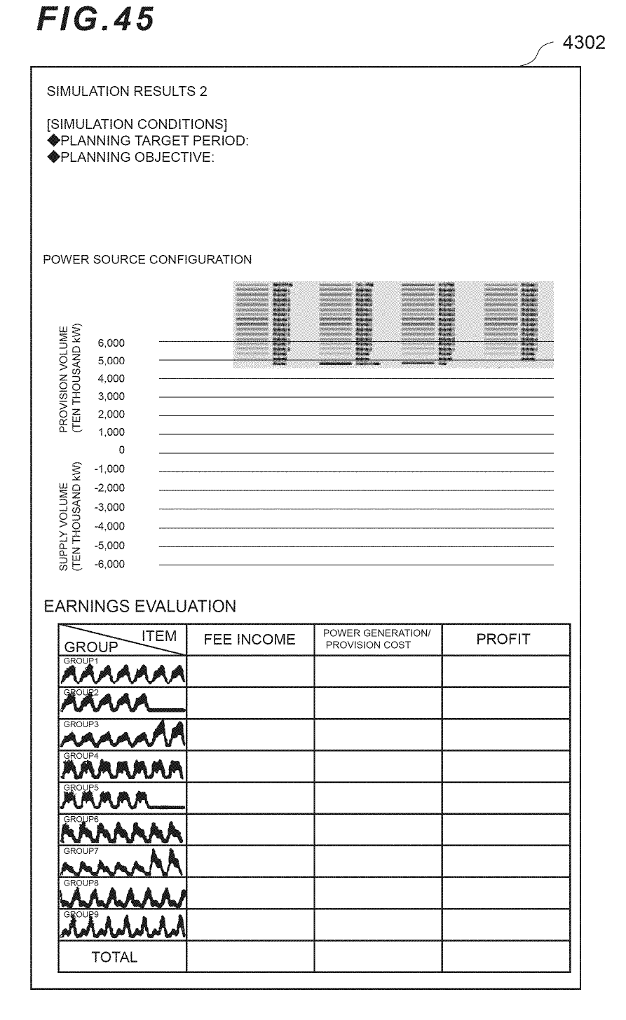

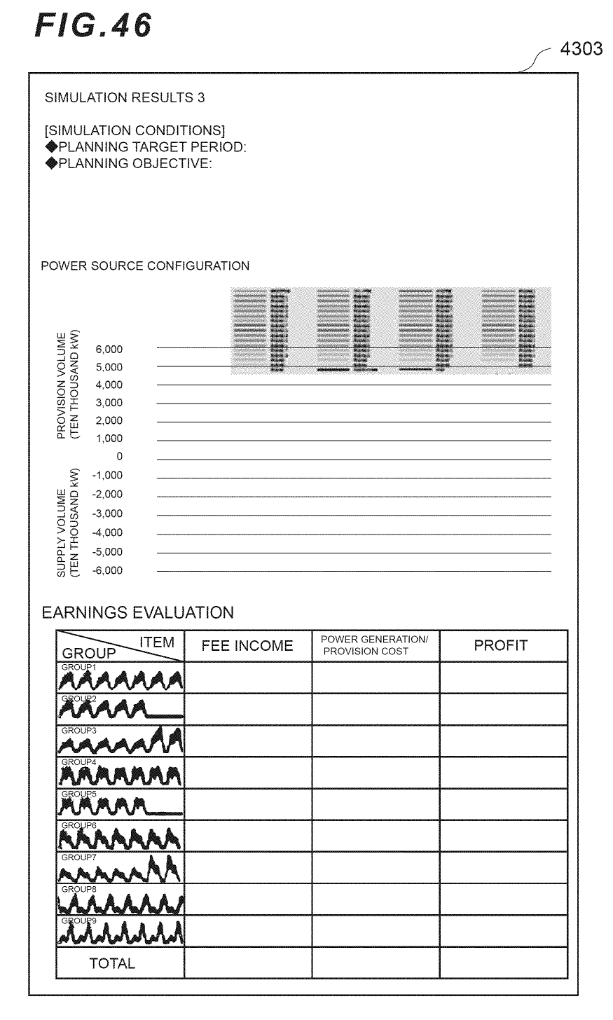

When the save results button in FIG. 38 is pressed, the search results are each saved in a database and posted on the power source configuration determination simulation results screen 4300 (FIG. 43). The screen 4300 shown in FIG. 43 displays information parts 4301 to 4303 (FIGS. 44 to 46) which show the simulation results 1 to 3, for example.

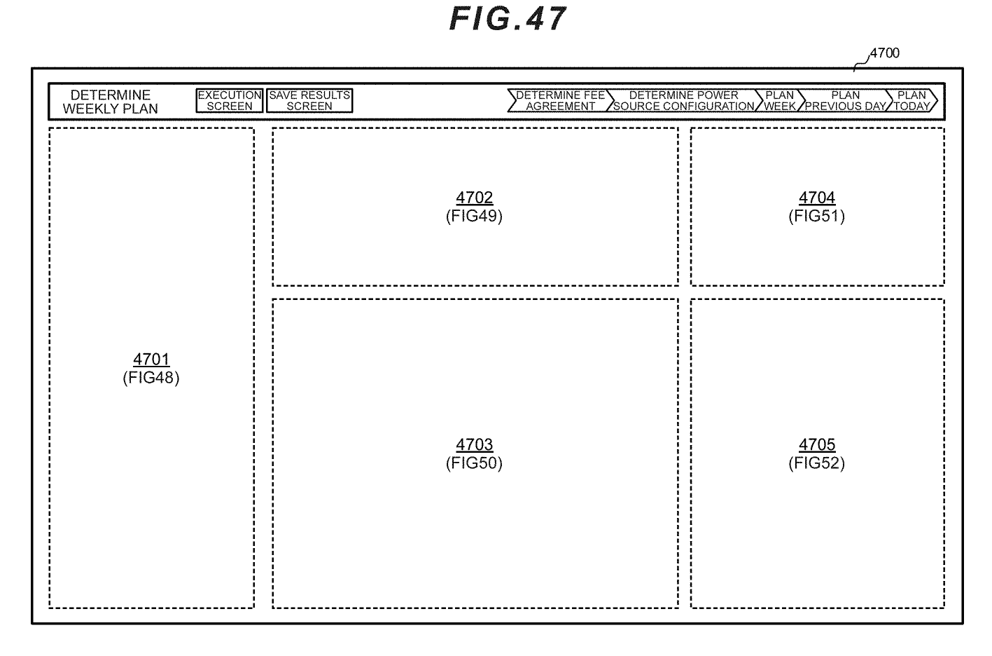

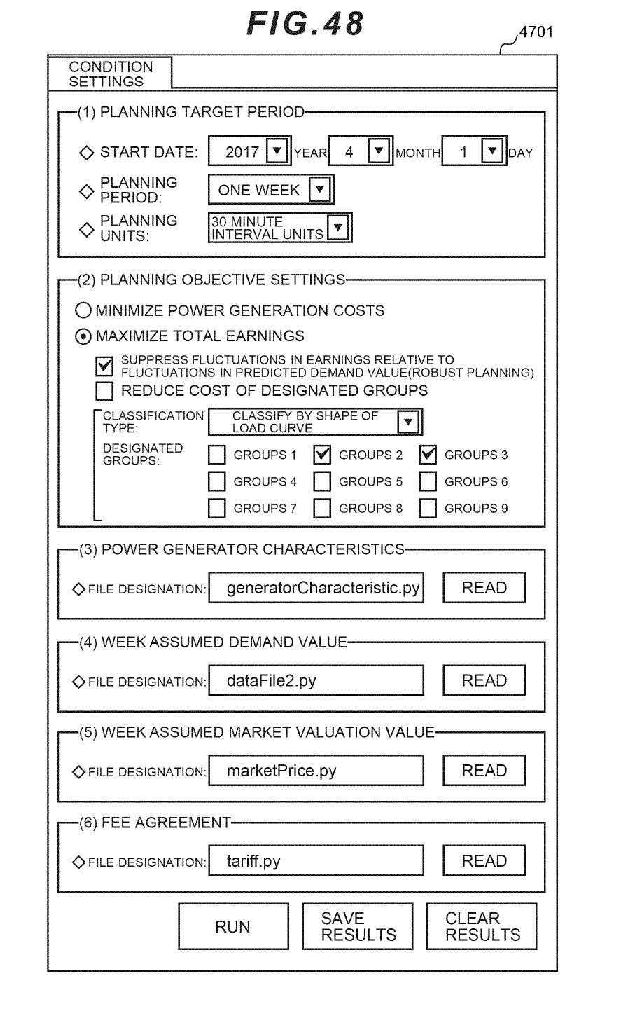

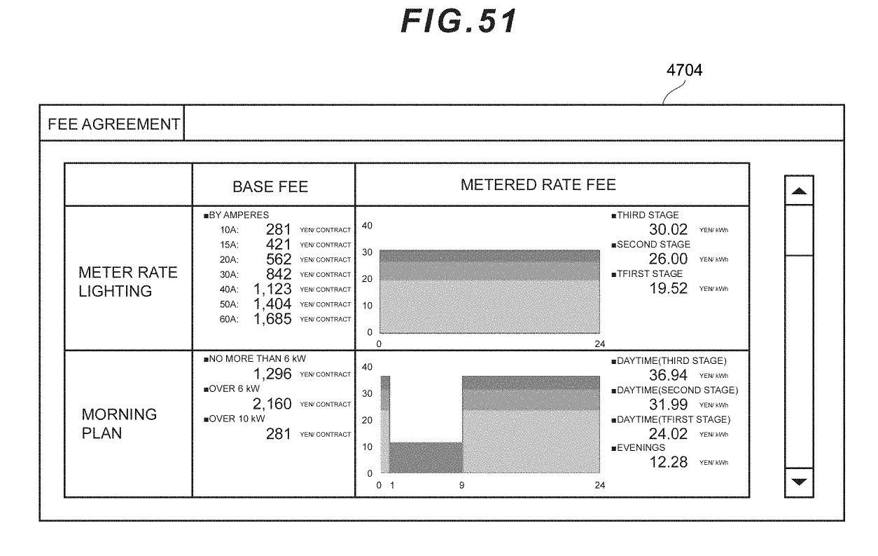

The processor unit of the management apparatus displays a screen 4700 which relates to execution and is illustrated in FIG. 47 for STEP4. More specifically, FIG. 47 shows the overall configuration of the weekly plan determination screen 4700. Information parts 4701 to 4705 shown in FIGS. 48 to 52 are each displayed on the screen 4700. The specific details are as follows.

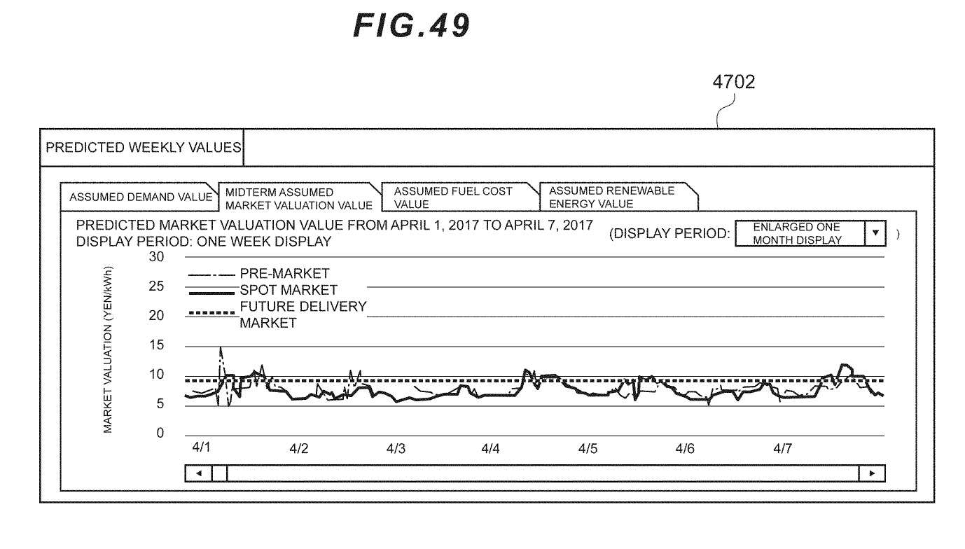

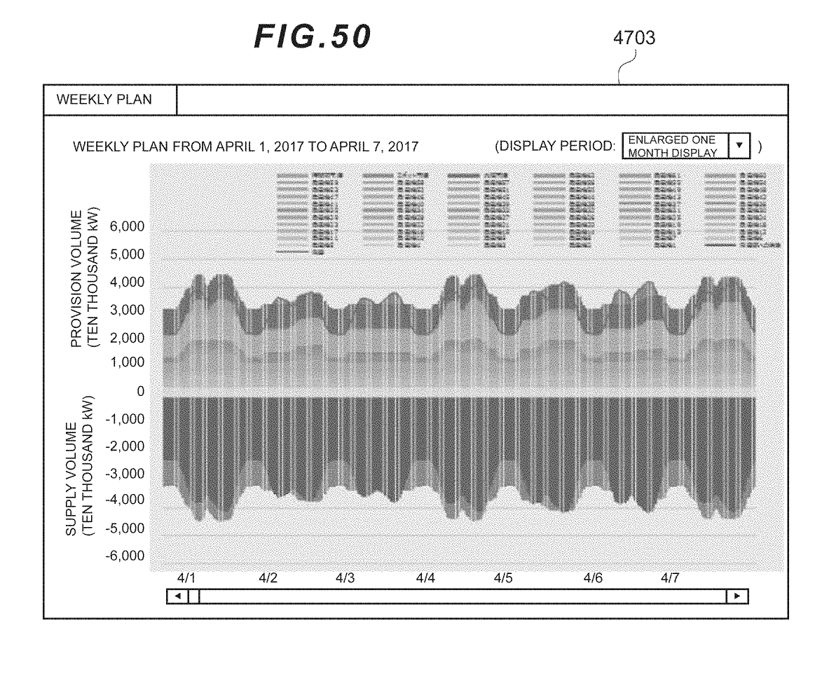

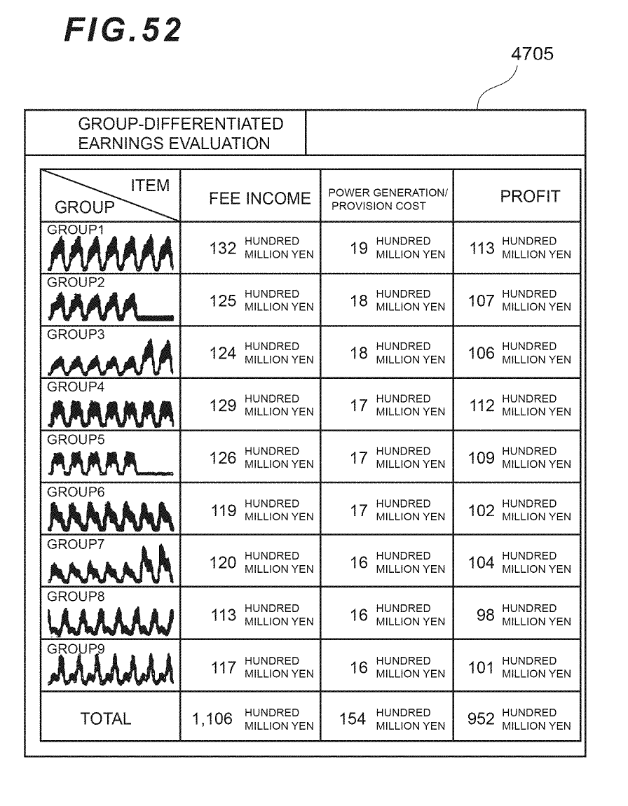

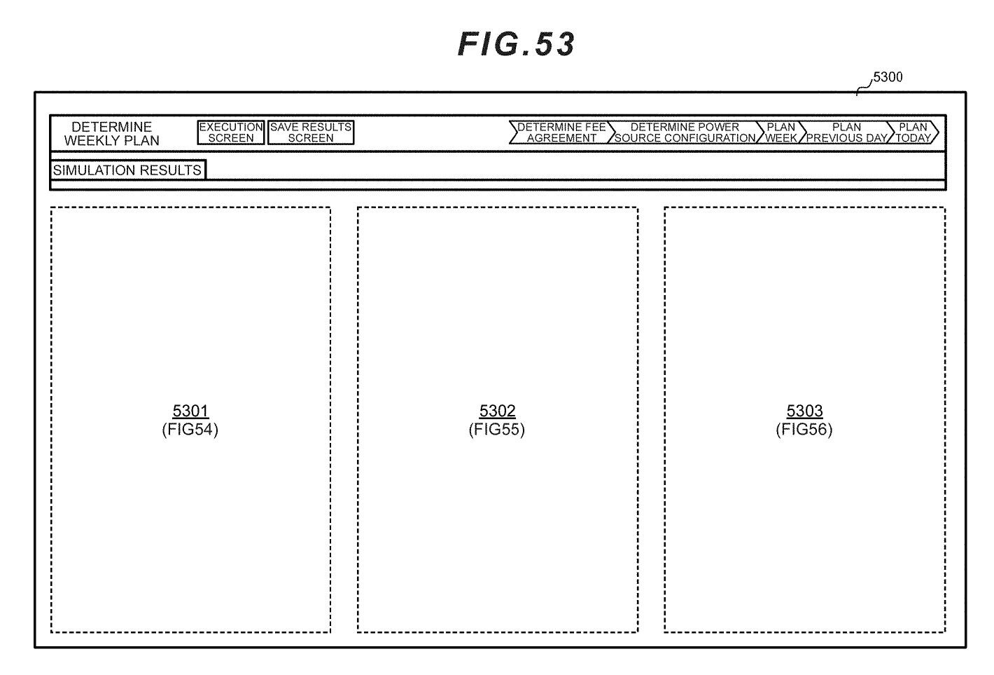

(FIG. 48: information part 4701) A search for a fee unit price (fee menu) and a power source configuration is made, inputs selected by the user are accepted (processed via a screen which is not shown), and one week's worth of power trading is planned based on these conditions. To select a power configuration, any search conditions which are desirable to the user are input for the search (executed via FIGS. 37 and 43). The designated search conditions are posted to the weekly plan determination screen as the default values of the ‘planning objective settings’ checkbox (center right in FIG. 47).
(FIG. 48: information part 4701) Generator characteristics and predicted demand values (recreated at any time based on a weekly weather report and stored in a database), which are used in the weekly plan, and predicted market price values are read and designated (predicted values for renewable energy volumes are also updated at any time according to weather report updates and stored in a database, and then read to determine a weekly plan). (Left side of FIG. 47).
(FIG. 49: information part 4702) Numerical values relating to the search conditions thus read (demand, market price, and fuel costs) and past and future renewable energy volumes which are stored in the database are displayed (‘predicted weekly values’ in the center top of FIG. 47).
(FIG. 50: information part 4703) By pressing the ‘run’ button in FIG. 48, the weekly, the results of searching for the weekly power source configuration and the supply thereof (sale) are displayed in a bar graph in which time is plotted on the horizontal axis (displayed in periods of a quarter or one year), the provision volume is plotted on the upper half of the vertical axis (proportions of provisioned power from supply sources and markets are displayed in a bar graph for each delivery time interval) and the corresponding supply volume in each delivery time interval is plotted on the lower half of the vertical axis (company's own sales to consumers and sales volumes to the market) (the ‘weekly plan’ display portion in the lower center section of FIG. 47).
(FIG. 52: information part 4705) The demand category-differentiated sales income (′fee income′), costs (‘power generation provision costs’), and earnings (‘profits’) are output for each search result. (The ‘group-differentiated earnings evaluation’ display portion in the bottom right of FIG. 47.

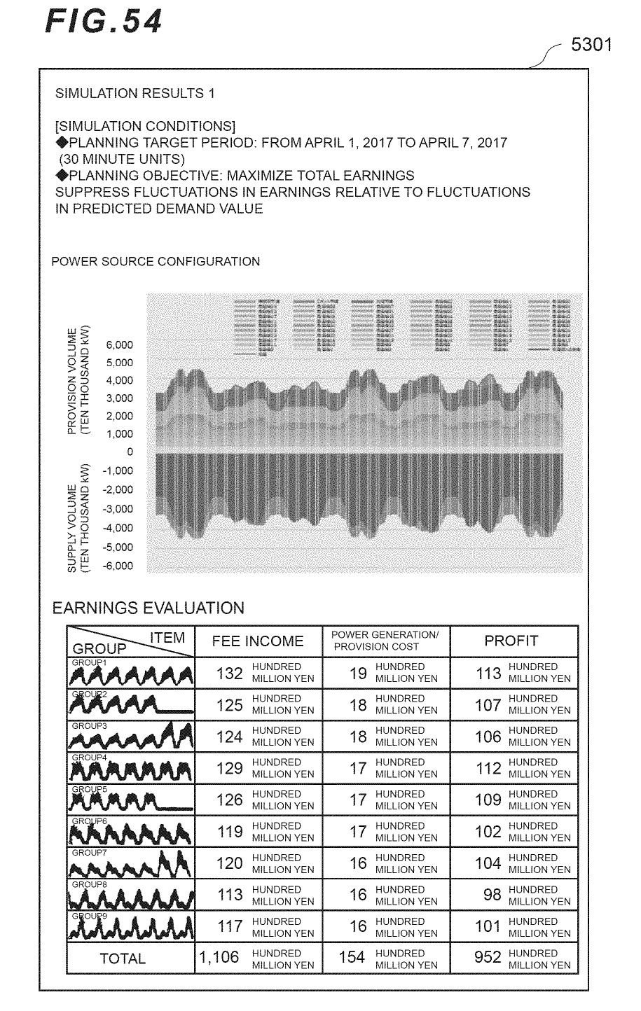

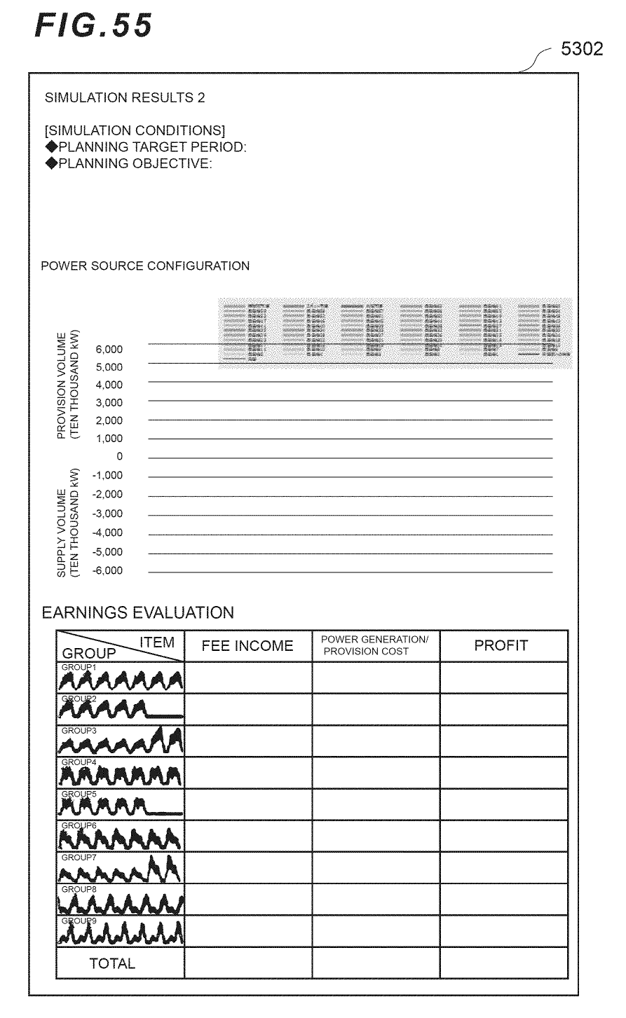

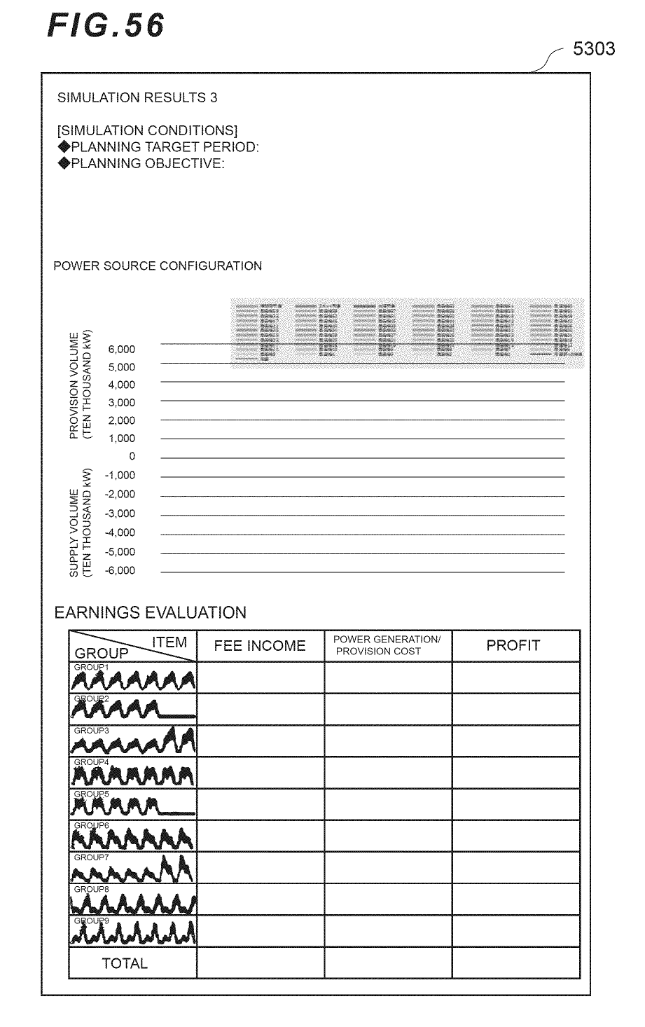

When the save results button in FIG. 48 is pressed, the search results are each saved in a database and posted on the power source configuration determination simulation results screen 5300 (FIG. 53). The screen 5300 shown in FIG. 53 displays information parts 5301 to 5303 (FIGS. 54 to 56) which show the simulation results 1 to 3, for example.

The present invention is not limited to or by the foregoing embodiments and encompasses a variety of modification examples. Furthermore, a portion of the configuration of a certain embodiment can be replaced by the configuration of another embodiment, or the configuration of another embodiment can be added to the configuration of a certain embodiment. Moreover, a portion of the configuration of each embodiment can have other configurations added thereto or can be removed or replaced.

1. A management apparatus, comprising:
a sales income calculation unit which calculates sales income derived from supplying demand by using a time interval-differentiated fee unit price for each demand category and a power usage value;
an earnings prediction spread calculation unit which compares earnings for each of a plurality of future volume estimation time series relating to power usage volumes of predetermined periods of the demand categories;
and a fee unit price search unit which searches for a fee unit price satisfying a limiting condition based on a comparison result.

2. The management apparatus according to claim 1,
wherein the fee unit price search unit comprises a limiting condition input unit which inputs either of:
(a) upper and lower limit data for sales income amounts of each demand category; and
(b) upper limit data for an earnings prediction spread which is a difference in earnings calculated in each of a plurality of future scenarios.

3. The management apparatus according to claim 1,
wherein the demand category sales income is in a predetermined value range, and
wherein a time interval-differentiated unit price distribution ratio is adjusted.

4. A management apparatus, comprising:
a category-differentiated supply cost calculation unit which calculates supply costs differentiated by demand category;
a demand category-differentiated earnings calculation unit which calculates earnings which are the difference between supply costs and sales income of a predetermined demand category; and
a supply source search unit which searches for a combination of time interval-differentiated supply sources satisfying a limiting condition, based on the earnings.

5. The management apparatus according to claim 4,
wherein the supply source search unit comprises:
a limiting condition data input unit which minimizes or maximizes either the value of costs required for supplying a predetermined demand category or the value of earnings from supplying a predetermined demand category; or
a limiting condition data input unit which inputs an upper limit value or lower limit value for costs or earnings.

6. The management apparatus according to claim 4, further comprising:
a category earnings trial calculation unit which performs a category earnings calculation that includes a calculation of supply costs incurred in supplying a predetermined demand category and of the value of earnings from supplying the demand category; and
a demand category-differentiated predicted earnings spread calculation unit which compares demand category-differentiated earnings in a plurality of future scenarios,
wherein the supply source search unit searches for a combination of supply sources for which a predicted earnings spread of a demand category is minimum or no more than a predetermined value.

7. The management apparatus according to claim 1, further comprising:
a fee menu value difference estimation unit which estimates a value difference between a payment amount in a fee menu which is a change candidate, pertaining to an electric power fee to be paid by a consumer, and a pre-change fee menu payment amount;
a fee menu-differentiated contract proportion estimation unit which estimates a selection proportion of each fee menu in a future plan period, based on a fee menu value difference estimation amount;
a sales income calculation unit which calculates sales income based on the payment amount;
a fee menu-differentiated contract proportion limiting condition input unit which designates an increase/reduction rate of a fee menu-differentiated contract proportion of the demand category; and
a fee unit price search unit which determines the fee unit price for which the contract proportion or contract quantity is a predetermined value, based on a designated increase/reduction rate.

8. The management apparatus according to claim 4, further comprising:
a scenario management unit which calculates an earnings prediction spread using a first scenario which is a designated scenario, and an earnings prediction spread using a second scenario which is a scenario in which a demand value of a predetermined demand category or a supply value of a predetermined supply category is added to the demand and supply values of the first scenario, or these demand and supply values are changed; and
a demand or supply source additional effect trial calculation unit which compares and displays the earnings prediction spread using the first scenario and the earnings prediction spread using the second scenario.

9. A management method, comprising:
calculating sales income derived from supplying demand by using a time interval-differentiated fee unit price for each demand category and a power usage value;
comparing earnings for each of a plurality of future volume estimation time series relating to power usage volumes of predetermined periods of the demand categories; and
searching for a fee unit price satisfying a limiting condition based on a comparison result.

10. A management method, comprising:
calculating supply costs differentiated by demand category;
calculating earnings which are the difference between supply costs and sales income of a predetermined demand category; and
searching for a combination of time interval-differentiated supply sources satisfying a limiting condition, based on the earnings.

11. The management method according to claim 9, further comprising:
estimating a value difference between a payment amount in a fee menu which is a change candidate, pertaining to an electric power fee to be paid by a consumer, and a pre-change fee menu payment amount;
estimating a selection proportion of each fee menu in a future plan period, based on a fee menu value difference estimation amount;
calculating sales income based on the payment amount;
designating an increase/reduction rate of a fee menu-differentiated contract proportion of the demand category; and
determining the fee unit price for which the contract proportion or contract quantity is a predetermined value, based on a designated increase/reduction rate.

12. The management method according to claim 10, further comprising:
calculating an earnings prediction spread using a first scenario which is a designated scenario, and an earnings prediction spread using a second scenario which is a scenario in which a demand value of a predetermined demand category or a supply value of a predetermined supply category is added to the demand and supply values of the first scenario, or these demand and supply values are changed; and
comparing and displaying the earnings prediction spread using the first scenario and the earnings prediction spread using the second scenario.
